(19) United States
(12) Patent Application Publication
(10) Pub. No.: US 2023/0306466 A1
(43) Pub. Date: Sep. 28, 2023

(54) ARTIFICIAL INTELLEGENCE ENGINE FOR GENERATING SEMANTIC DIRECTIONS FOR WEBSITES FOR ENTITY TARGETING

(71) Applicant: THE DUN & BRADSTREET CORPORATION, SHORT HILLS, NJ (US)

(72) Inventors: Alex Schwarm, Austin, TX (US); Paul Azunre, Austin, TX (US); Jun Li, Brooklyn, NY (US); Gilbert Slade, Austin, TX (US)

(73) Assignee: THE DUN & BRADSTREET CORPORATION

(21) Appl. No.: 18/189,866

(22) Filed: Mar. 24, 2023

Related U.S. Application Data
(60) Provisional application No. 63/324,256, filed on Mar. 28, 2022.

(51) Int. Cl. G06Q 30/0251; G06F 40/30; G06F 40/284

(52) U.S. Cl. CPC G06Q 30/0263; G06F 40/30; G06F 40/284

(57) ABSTRACT

A method and system for employing a Language Processing machine learning Artificial Intelligence engine to employ word embeddings to create numerical representations of document meaning in a high-dimensional semantic space or an overall semantic direction. A system and method configured to improve precision and scale when using simple static embeddings. The system is programmed to employ innovative algorithms that act as heuristics to eliminate bad contextual matches to improve accuracy and precision. Pretrained neural language models and contextual embeddings are configured automatically take context into account at the featurization stage. A system and method for one-class classification framework, which starts from a list of keywords of interest and is configured to build an intent/no intent classifier without any labels.

### CROSS REFERENCE TO RELATED APPLICATION

The present application claims the benefit under 35 U.S.C. § 119 of U.S. Provisional Patent Application No. 63/324,256, filed on Mar. 28, 2022, the contents of which are incorporated herein by reference.

### BACKGROUND OF THE DISCLOSURE

### 1. Field of the Disclosure

The present disclosure relates to a system and a method for Business Intelligence, Customer Relationship Management (CRM) Systems, Marketing Automation Platforms, and Web Analysis Systems.

### 2. Description of the Related Art

Current systems for analysing intent, for example as used by CRM Systems, Business Intelligence, and Web Analysis Systems, force marketers to select a set of single words to use for determining what a potential prospect may be searching for related to their product.

Marketers must make a mental map of their product and positioning to a set of these arbitrarily defined keywords.

This leads to inaccurate results from words with multiple meanings, other linguistic issues, for example such as jargon use, or simply missing the “right words.”

This also forces a difficult setup experience by making marketers search through up to 2,000 or more words to find the words that are related to their product. Even in the case where the key words can be chosen, the same linguistic and mapping issues arise.

### SUMMARY OF THE DISCLOSURE

The following briefly describes a basic understanding of some aspects of the embodiments. Its purpose is merely to present some concepts in a simplified form as a prelude to the more detailed description that is presented later.

Described herein are embodiments of a computer system, method, and computer program products for using machine intelligence.

In an embodiment, the system is configured to define a “Semantic Direction” for a set of content based on converting the words used in the content (and the usage of words across the entire data set) to a numerical representation of the meaning of the content. This allows the system to convert a client user's product content to a “Semantic Direction.”

In an embodiment, the system can calculate the “signal strength” for a given prospect business entity and the client user's product content, measure the change in signal strength to determine if there was a statistically significant change, and provide a client with information on prospect companies, for example:

Cross Sell Opportunity: For an existing customer, a significant increase in product signal strength for a different product.

New Sales/New Logos: A significant increase in product signal strength for business entities that are not existing customers of the client user.

Potential Larger Sales: For business entities that are not existing customers, a significantly higher product signal strength compared to other similarly identified business entities.

The arrangement of databases, mapping, and classifiers provide an improved prospect targeting platform that includes the following, non-limiting advantages over current Customer Relationship Management (CRM) systems.

### No Keywords Needed

The client user's description of their product and the content being viewed by the prospect is used to determine if there is alignment and interest; there is no filter that both pass through that is based on arbitrarily defined keywords. While keywords can still be used, they are no longer required.

There is no artificial, restrictive taxonomy that must be used for defining products and content.

Higher confidence results are obtained using meanings derived from entire documents rather than individual words or phrases (that could have multiple meanings or other linguistic issues).

### Clear and Actionable Insights, Automated and Rapid Value Delivery

Clear and time-relevant reports and interfaces that immediately uncover opportunities for: cross-sell, new sales, and larger sales.

Leverages the best word embedding artificial intelligence models, for example one or more of word2vec, BERT, ALBERT, ELMo, etc., and training on huge databases of content (600B words).

Automated analysis is done based on a client user's own web content or any other supplied product content.

### Detect Signal Strength for ABM Engagements and Complex Family Trees

Enables signal strength to be generated based on business identities and family trees (rather than just domains), a critical element for Account Based Marketing (“ABM”) and determining intent.

Further non-limiting advantages of the innovations described herein include the following:
Improvements to systems that leverage defined keywords from human subjective judgement.
The automated analysis of very large quantities of content text while retaining very nuanced semantic representation of the content.
The automated analysis of product content while retaining very nuanced semantic representation of the product content.
The ability to easily scale to very large numbers of specific types of product-oriented audiences and then use this to create many specific product-oriented taxonomies in marketplaces related to programmatic advertising.

In embodiments, described are systems and processes therefor configured to perform analysis for a single product or a similar family of products that a client sells, which can also be applied to other products or product families. Described herein are embodiments of a system and processes therefor, configured to collect all words presented in the web page content and classify the word content by employing a language processing classifier. In an embodiment, the system configured with a natural language processing (NLP) classifier including word embeddings and term frequency. In another embodiment, the system is configured to with a language-model-based system. The system is configured to vectorize the unstructured text and define a “semantic direction” associated with the web page content and the corresponding product.

Accordingly, in an embodiment, described herein is a method, and computer system and computer program product for the method being performed by a computer system that comprises one or more processors and a computer-readable storage medium encoded with instructions executable by at least one of the processors and operatively coupled to at least one of the processors, the method comprising: analyzing a set of web data traffic content for a website, the web data content comprising content such as web page content being accessed, mobile IDs, IP addresses, and web browser cookies. The system can be configured to map the web data traffic content to a business entity identifier to identify a business entity visiting the website; map the web traffic data content to personnel data for the business entity associated with the business entity identifier to identify business personnel associated with the business entity visiting the website; and for each webpage address of the website accessed by the business entity or the business personnel associated with the business entity identifier, generate a word database comprising words from the webpage at the webpage address. The system can be configured to analyze the word database with a language processing classifier to generate word embeddings; generate a semantic direction value for the word database; and identify the business entity intent based on the semantic direction value.

Accordingly, embodiments as described herein provide a technology solution that improves over conventional CRM Systems, Business Intelligence Systems, and Web Analysis Systems, which rely on subjective human judgement and less robust prospect identification. Such systems introduce mistargeting, and further fail to identify proper prospects. For example, because Zappos has shown increased interest in CRM software does not mean that Amazon.com will be buying new CRM software. Likewise, if Amazon Web Services HQ, Amazon Web Services Germany, and Amazon Web Services Australia are all showing increased interest in accounting firms, that is a stronger signal than just having many visitors just from Amazon Web Services HQ.

Embodiments as described herein can be used to define audiences that are demonstrating interest or intent to buy products based on the characteristics of content that an audience is engaging with online. The methodology leverages language processing techniques, such as word embeddings to create numerical representations of document meaning in a high-dimensional semantic space or an overall semantic direction. This semantic direction can be used to quantitatively measure semantic similarity between online content consumed by a potential prospect and a given product or product family. The count of visitors for a given prospect company that is consuming content with a high degree of semantic similarity can then be tracked over time and, if a significant increase is detected, the prospect company can be inferred to have an increased level of intent or interest in a given product. This same analysis can be executed not just for a single business entity; it can also be applied to measure intent across entities within a family tree context. Furthermore, this capability can be used to automate the process of creating audiences for on-line marketplaces for programmatic advertising purposes by using representative product descriptions, such as a grouping of product descriptions for scalable, cloud-based databases, and then creating a hyper-focused intent-based audience based on companies that are showing a significant increase in intent based on the aforementioned methodology. Further, language processing and word embeddings can be used to analyze tera-scale data sets to determine audiences and measure intent related to a specific audience. In at least one embodiment, the system can be configured to employ definitions for different types of products.

### BRIEF DESCRIPTION OF THE DRAWINGS

Embodiments will now be further described, by way of example only, with reference to the accompanying drawings.

FIG. 1 is a block diagram of logical architectures for an embodiment.

FIG. 2 is a diagram of a flow chart showing a process in accord with an embodiment.

FIGS. 3A-3D are diagrams of flow charts in accord with an embodiment.

FIG. 4 is a diagram of a flow chart showing a process in accord with an embodiment.

FIG. 5 shows an example graphical user interface according to an embodiment.

FIG. 6 shows an example graphical user interface according to an embodiment.

FIG. 7 shows an example graphical user interface according to an embodiment.

FIG. 8 shows an example graphical user interface according to an embodiment.

FIGS. 9A-9D show example embodiments of environments in which the present embodiments can be practiced.

FIG. 10 shows an embodiment of a network computer that can be included in a system such as that shown in FIGS. 9A-9D.

FIG. 11 shows an embodiment of a client computer that can be included in a system such as that shown in FIGS. 9A-9D.

### DETAILED DESCRIPTION OF THE EMBODIMENTS

Various embodiments now will be described more fully hereinafter with reference to the accompanying drawings, which form a part hereof, and which show, by way of illustration, specific embodiments by which the disclosure may be practiced. The embodiments can, however, be embodied in many different forms and should not be construed as limited to the embodiments set forth herein. Rather, these embodiments are provided so that this disclosure will be thorough and complete, and will fully convey the scope of the embodiments to those skilled in the art. Among other things, the various embodiments can be methods, systems, media, or devices. The following detailed description is, therefore, not to be construed in a limiting sense.

Throughout the specification and claims, the following terms take the meanings explicitly associated herein, unless the context clearly dictates otherwise. The term “herein” refers to the specification, claims, and drawings associated with the current application. The phrase “in embodiments” or “in embodiments” as used herein does not necessarily refer to the same embodiment, though it may. As described below, various embodiments of the present disclosure can be readily combined, without departing from the scope or spirit of the present disclosure.

In addition, as used herein, the term “or” is inclusive, and is equivalent to the term “and/or,” unless the context clearly dictates otherwise. In addition, throughout the specification, the meaning of “a” “an” and “the” include plural references. The meaning of “in” includes “in” and “on”.

In the following detailed description reference is made to language processing which is a field of computer science, artificial intelligence (AI), and computational linguistics concerned with the interactions between computers and human (natural) languages. One AI data analysis approach is based on identifying semantic directions, which is an AI task.

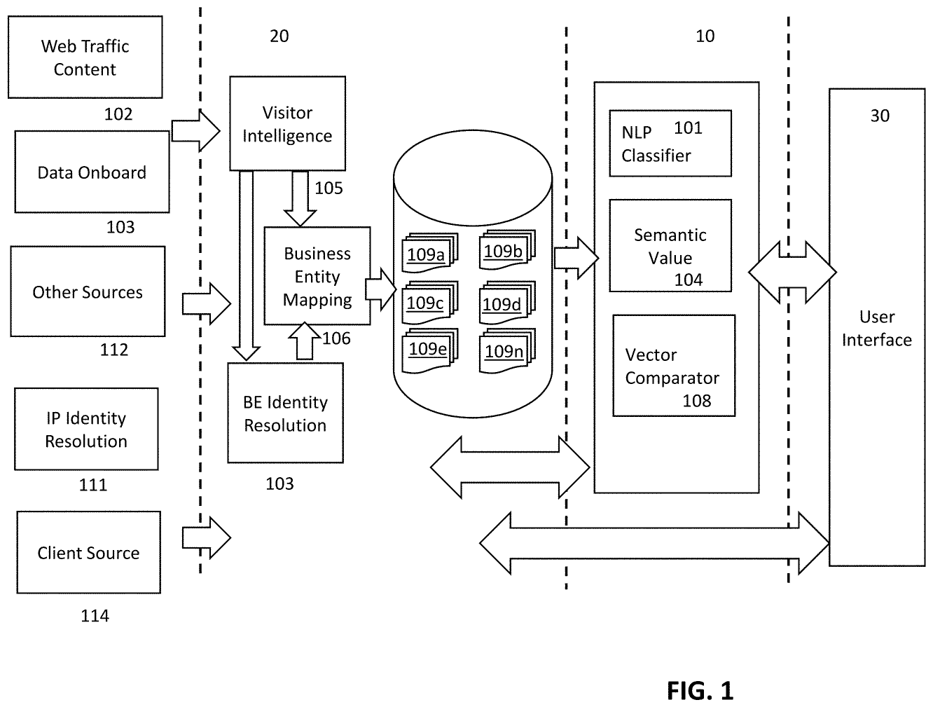

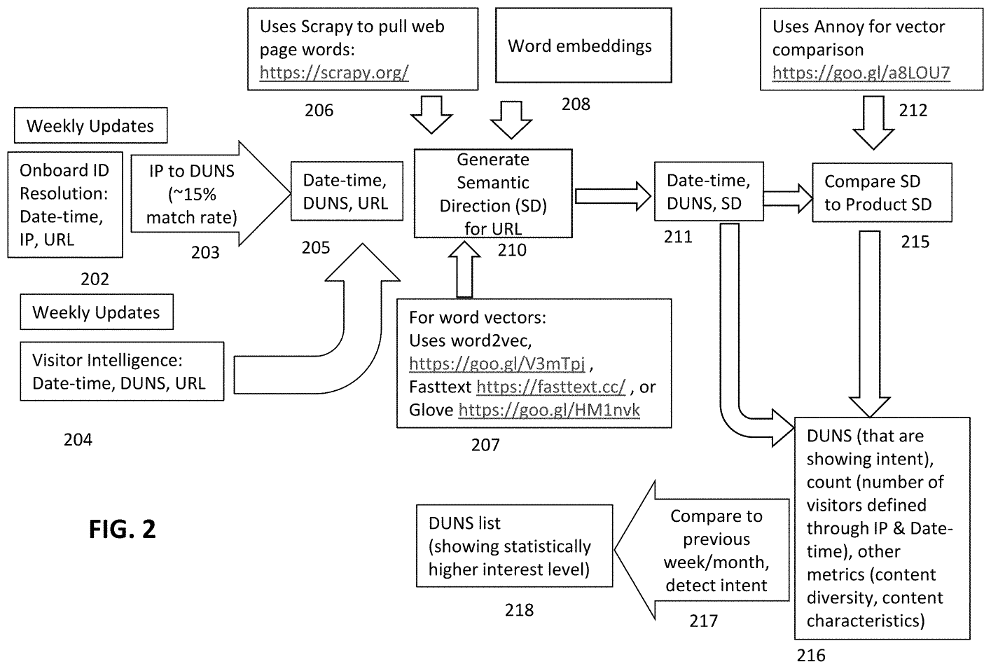

Referring to FIG. 1, the system is generally represented by reference numeral 100 and illustrates a block diagram of logical architectures and modules for an embodiment. FIG. 2 is a flow chart showing a process in accordance with the embodiment. At block 202, the system is configured to analyze a set of web data traffic content 102 for a website. The web data content can be the web page content being accessed (e.g., an article, a product page, any web page from a site), IP addresses, mobile IDs, and web browser cookies. For example, in an embodiment, the system can be configured to include or interface with an identity resolution and data onboarding platform 107. For example, the system could perform identity resolution or interface with platforms 111, 112, 107, 114 (for example, platforms such as LiveRamp™, Neustar™, Acxiom™, etc.) to access and onboard web data traffic content 102 or perform or obtain identity resolution data for business entities associated with an IP address. Identity resolution can be done using IP Identity Resolution technology platforms 111 and tools as known in the art, for example, by matching cookie data to IP addresses, synching cookie pools, etc. Data can also include data provided by client sources 114, such as, for example, keyword lists.

At block 203 the system is configured to obtain the web traffic content data 102. For example, at block 203 a business entity analytics platform server 20 can comprise a business entity identity resolution module that matches each of the web traffic IP addresses with a business identification number, for example, a DUNS number (hereinafter referred to simply as “DUNS”), from a business entity information database. In an embodiment, initial mapping in a robust business information database can be, for example, at a 10-20% percent match rate (e.g., 15%).

In an embodiment, at block 203 the system can be configured to identify, for a given business entity identifier, a number of other, unique business entity identifiers in a business organizational tree for the given business entity identifier. For example, for a given DUNS number, the system can be configured to calculate the number of unique DUNS numbers associated with an appropriate family tree representation related to this given DUNS number. The family tree representations associated with a given DUNS number can comprise, for example, common franchisees, DUNS with minority ownership, DUNS that are all beneath a headquarters with a high propensity to be a buying decision maker for the family tree members underneath (such as identified by Dun & Bradstreet's Decision HQ platform); DUNS with a common headquarters, a common domestic ultimate, or a common global ultimate based on legal connections (less than 50% ownership); DUNS with a common headquarters, a common domestic ultimate, or a common global ultimate based on analysis of brands used within a set of DUNS, DUNS with a common headquarters, a common domestic ultimate, or a common global ultimate based on a combinations of the aforementioned items. An exemplary system for linking a given business entity identifier, a number of other, unique business entity identifiers in a business organizational tree for the given business entity identifier is described in U.S. patent application Ser. No. 14/926,033, U.S. Pat. Pub. No. 2017-0124132 A1, filed on Oct. 29, 2015, and entitled “Data Communications System and Method that Maximize Efficient Usage of Communications Resources”, the entirety of which is incorporated by reference hereby.

The system can also include a business entity mapping module 106 that is configured to analyze and map web traffic content data for personnel data for the business entity associated with the business entity identifier, for example to identify business personnel by Job Function, Job Title, Persona Related, and Job Seniority.

At block 204, the system is configured to obtain visitor intelligence data 105, and at block 205 the business entity mapping module 106 is configured to map the web traffic data content 102 to visitor intelligence data 105, for example, personnel data for the business entity associated with the business entity identifier to identify business personnel associated with the business entity visiting the website.

Non limiting examples of company entity data linking, generating firmographic databases and scoring for companies, and data integration from a business entity information database by a business analytics server are described in U.S. Pat. No. 7,822,757, filed on Feb. 18, 2003 entitled “System and Method for Providing Enhanced Information”, and U.S. Pat. No. 8,346,790, filed on Sep. 28, 2010 and entitled “Data Integration Method and System”, the entirety of each of which is incorporated by reference herein. The firmographic or other attribute data (e.g., the company name, address, and ranking/evaluation/risk scores) can also be associated with the entity that owns the IP address.

At block 205, the system is configured to map the web data traffic content 102 to a business entity identifier to identify a business entity visiting the website.

At block 206, for each webpage address of the website accessed by the business entity or the business personnel associated with the business entity identifier, the system is configured to generate a word database 109a-109n comprising words from the webpage at the webpage address. For example, in an embodiment, the system can employ a web data extraction tool, for example, an application framework for crawling web sites and extracting structured data. An example of such an application framework includes the Scrapy 1.5 web crawling and scraping application, which can be used for a wide range of useful applications, like data mining, information processing or historical archiving. In an embodiment, the word database 109a-109n can include key words or phrases provided from a client, source 114 by a client or customer user.

At block 207, the system is configured analyse the word database with a language classifier 101 configured to generate word embeddings. In an embodiment, the language processing classifier configured to analyze the word database with a Natural Language Processor (NLP) classifier 101. In an embodiment, the system is configured to include vector comparator 108 comprising a word vector classifier, for example a trained classifier module such as Fasttext (Fasttext: P. Bojanowski*, E. Grave*, A. Joulin, T. Mikolov, Enriching Word Vectors with Subword Information); Global Vectors for Word Representation GloVe (GloVe: Global Vectors for Word Representation Jeffrey Pennington, Richard Socher, Christopher D. Manning Computer Science Department, Stanford University, Stanford, CA 94305 jpennin@stanford.edu, richard@socher.org, manning@stanford.edu); or Word2vec: Mikolov, Tomas; et al. “Efficient Estimation of Word Representations in Vector Space”. arXiv:1301.3781.

In an embodiment, the language processing classifier 101 is configured to employ a language-model-based classifier module to generate the word embeddings. The classifier generates word embeddings by mapping each word to a vector to produce on a large set of contextual information that is related to the word being mapped. The vector is not only determined by the word itself; it is also determined by other words before and after the word that is being mapped to a vector. Language-model-based classifier modules can include a language model such as ElMo (Peters, Matthew E., Neumann, Mark, Iyyer, Mohit, Gardner, Matt, Clark, Christopher, Lee, Kenton and Zettlemoyer, Luke, “Deep Contextualized Word Representations,” Proc. of NAACL, 2018); a BERT module (3: Jacob Devlin, Ming-Wei Chang, Kenton Lee, Kristina Toutanova, “BERT: Pre-training of Deep Bidirectional Transformers for Language Understanding”, arXiv:1810.04805 [cs.CL], 2018); or XLNet (4: Zhilin Yang, Zihang Dai, Yiming Yang, Jaime Carbonell, Ruslan Salakhutdinov, Quoc V. Le, “XLNet: Generalized Autoregressive Pretraining for Language Understanding”, arXiv:1906.08237 [cs.CL], 2019).

At block 208, in an embodiment, the system scores and weights the vector space using a vector scoring module 107. In an embodiment, the system is configured to can analyze the word database 109a-n employing word embeddings to analyze the word database. For example, the system is configured to analyze the word database 109a-n with a machine learning model selected including word embeddings, which is used by a semantic value module 104 to generate a semantic direction value to identify the business entity intent based on the semantic direction value.

The system can be configured to establish a word embeddings model comprising a semantic vector generated for a dictionary which includes singular words (unigrams) and groups of words (n-grams), wherein the frequency of co-occurrence of words within a defined window within the corpus creates a correlation between words that generates a semantic relationship between words. The system can be configured to identify the ngrams across the corpus such that unigrams within a ngram are not represented in the analysis. For example, first, a word embeddings model is created, or an existing model is used such as those that have been created through Google [Tomas Mikolov, Kai Chen, Greg Corrado, and Jeffrey Dean “Efficient Estimation of Word Representations in Vector Space”. In Proceedings of Workshop at ICLR, 2013.], GloVe [Jeffrey Pennington, Richard Socher, and Christopher D. Manning. 2014, “GloVe: Global Vectors for Word Representation”.], Fasttext ([Bojanowski, Piotr, Grave, Edouard, Joulin, Armand, Mikolov, Tomas, “Enriching Word Vectors with Subword Information”, arXiv preprint arXiv:1607.04606, 2016]), or ELMo [Peters, Matthew E., Neumann, Mark, Iyyer, Mohit, Gardner, Matt, Clark, Christopher, Lee, Kenton, Zettlemoyer, Luke, “Deep contextualized word representations”, Proc. of NAACL,). 2018]). This model is created employing a standard methodology where a semantic vector is created for a dictionary which includes singular words (unigrams) and groups of words (n-grams). The frequency of co-occurrence of words or subwords within a defined window within the corpus creates a correlation between words or subwords that generates a semantic relationship between them. This word embeddings model, which typically translates a word into a 300-dimensional numeric vector, can be used as a core component in creating the semantic direction of a given document or set of content.

As described above the system can be configured to generate the semantic value using a number of vector modules, for example, run with scikit-learn, spaCy NLP (v2.0), Natural Language Toolkit (NLTK 3.4.4). TensorFlow (APR 1, 2) PyTorch (1.1.0), scikit-learn (0.21.02), or Gensim (3.8.0). For example, the system can also be configured to run TensorFlow or PyTorch to run neural nets such as ELMo (0.8.4) or BERT to generate word embeddings with context to obtain word embedding values together with the semantic values.

In an embodiment, the system language processing classifier 101 is also configured with another classification model to classify the content being consumed by the visitors into buying content and non-buying. If a set of visitors are predominantly consuming content related to buying, then those visitors are classified as being in a buying state. If visitors are consuming content that is not related to buying (e.g.: predominantly more informational content or content related to learning) then those visitors as classified a relatively lower buying state. The system can also be configured to provide a score as to the confidence as to whether that content is related to buying. The classification can be performed by classifiers as described herein, for example Fasttext, ELMo, BERT, or XLNET. The model is trained on the corpus of text that has been classified, and then the classifier used to classify whether a webpage is related to buying, as well as a confidence score associated with that classification. For example, a set of visits for a specific company over a specified time frame can be assessed by analyzing the scores for all of these visits. The system can be configured to employ any number of analyzers to assess these combined sets of visits, and thus assess the buying intent of the company associated with these visits. For example, an analysis module can be configured to averaging the results and generate a linear score from 0 to 100. For a nonlinear score, the analyzer can be configured to apply a softmax procedure to the analyzer result so that the output score will be between 0 and 100.

At block 210 the system is configured to generate a semantic direction value for the word database 109a . . . 109n and identify the business entity intent based on the semantic direction value.

In an embodiment, the system is configured to identify a number of the unique visitors to the website associated with the business entity identifier during a plurality of time intervals for a period of time. For example, at block 211, for each business entity that visited the website, the system logs the date and time, the business entity identifier mapped of the visitor, and the semantic direction value of the webpage.

The system can also be configured to generate the semantic direction value for the content and an identified product or product family. The system can be configured to calculate the similarity of a set of content or a document for a webpage to a product content, for example a product description for a product or family of products.

For example, in an embodiment, the system can be configured to generate a taxonomy of product types based on a representative product content. The system can then calculate a semantic value of a representative set of products. In an embodiment, the system employs a machine learning algorithm for document classification to classify and be applied to a database of product categories or text definitions for products to correlate the semantic direction with one or more entities. The system can then be configured to define a target product audience based on the correlation.

For marketplaces where a client's product information is not readily available, a taxonomy of product types can be created based on representative product content. For example, an audience could be created for security software by creating a semantic direction for a representative set of security software related products. Using an automated method, incorporating data sets that give text definitions of product categories or relate product categories with a specific company's specific products, a very large number of product-based audiences could be automatically created which would allow for hyper-targeting for very specific intent or interest.

Accordingly, an exemplary advantage of embodiments as described herein is the improvement of programmatic advertising technology. In programmatic advertising, companies typically go to a marketplace and select an audience based on criteria. Unfortunately, these criteria might not map to their specific product. Embodiments as described herein are configured to create a set of companies that have surging interest in very specific products. To do this, the system is configured to obtain and leverage text and definitions describing many different products to find the semantic direction to use to compare against the online content, and find any companies that have a surging interest in content that has a semantic direction that is closely aligned to this product semantic direction. For example, the product descriptions can be obtained from a set of documented product definitions, for example payroll management software as software used for tracking, or sets of representative product documentation, for example, a web page for ADP's payroll management products, and the web page for Intuit's payroll management products. Embodiments of semantic value generation as described herein improves programmatic advertising by the creation of thousands of product-specific audiences without having to do conventional keyword analysis or other more manual techniques.

In an embodiment, the system can be configured to compare a webpage semantic direction value with a product semantic direction value. For example, at block 212 the system can be configured with a vector comparator module 108, for example, a nearest neighbor engine. An exemplary vector comparison application framework for a vector comparator module 108 includes, Annoy (Approximate Nearest Neighbors Oh Yeah), a C++ library with Python bindings to search for points in space that are close to a given query point. It also creates large read-only file-based data structures that are mapped into memory so that many processes may share the same data. At block 215, the semantic direction values for the webpage URL as described herein is compared to the product semantic direction using the vector comparison. In an embodiment, the vector comparison can be calculated as a cosine angle or a Euclidean distance for the semantic directions for the set of content or document to the product content. As will be appreciated, other vector comparator modules 108 can be employed as well.

At block 216, the system is configured to correlate business entities with the semantic direction for the webpage and/or the semantic vector for the product or family of products, for example using the business entity mapping module 106. As will be appreciated, having objectively established the semantic direction for the website and/or products, the identified business entities DUNS that are showing intent can be targeted at a much more accurate and granular level, for example by count (number of visits (signals) defined through IP address and date-time) and other metrics (e.g., content diversity, content characteristics).

In an embodiment, the system employs recursive machine learning for system robustness, and to accurately and objectively measure intent and an intent change over time.

In an embodiment at block 202 the system collects a number the unique visits associated with the business entity identifier during plurality of time intervals for a period of time. For example, the system can be configured to collect the number of unique visits on a weekly time interval. The unique visits can then be updated at weekly intervals for a period of time, for example, three to twelve weeks. The system can then be configured to calculate the number of unique visits for each interval for the period of time and compare each interval to the prior interval, for example, the current week to the prior week. The system is then configured to identify any deviations by detecting a shift between the analyzed intervals and calculate the magnitude of the shift. For example, the system can be configured to calculate the statistical estimate as an inner quartile range or a median absolute deviation of the number of unique visits.

In an embodiment, the system is configured to perform the analysis using one or more time windows. For instance, the system can employ a plurality of time windows of different time intervals, for example, a weekly time interval, a bi-weekly interval, and/or a monthly interval. Other intervals can be employed, for example, a monthly interval, a bi-monthly interval, a quarterly interval, and so on. The system can be configured to recalculate the-statistical measures based on the number of unique visits for the period of time (e.g., 3-4 months) for each the plurality of time windows, e.g., each week, each bi-week, and each month. The system can then be configured to calculates the magnitude of the shifts based on the recalculations for the time windows.

In an embodiment, the system can be configured to collect the number of unique visitors associated with the business organizational tree (see block 203) for the given business entity identifier for a period of time. The system can then be configured to calculate the statistical measure, for example as an inner quartile range or a median absolute deviation of the number of unique visitors and unique business entity identifiers in the family tree.

For example, in an embodiment, the system is configured to use standard statistical techniques to detect shifts in the number of unique visits for a business identifier (e.g., a DUNS number) for a business entity or a business identifier for an appropriate family tree representation. An example of this includes: collecting the number of unique visits and the number of web traffic signals-associated with each DUNS on a weekly basis for a period of time, such as eight weeks. The system then can calculate an appropriate robust statistic, such as inner quartile range or median absolute deviation, of the number of unique visits and web traffic signals in a defined family tree representation. The system then is configured to apply this analysis using weekly windows, biweekly windows, and monthly windows. These estimates are used to identify spikes or shifts in the number of unique visits and number of total signals by detecting shifts that are significant. Possible measures for statistically significant difference include an absolute difference between the median and the measured which is 1.5 times the inner quartile range, or 3 times the median absolute deviation. This is then calculated across weekly time scales, bi-weekly time scales, and monthly time scales to determine the magnitude of the shift. For example, for estimating weekly variance, the variance in the average number of weekly visits for a given DUNS for a given well-aligned semantic direction can be estimated as:

$${v}_{w} = \frac{1}{\sqrt{{n}_{w}}} {\sum }_{i = 1}^{{n}_{w}} {[ \overline{{x}_{l}} - {x}_{i} ]}^{2}$$

Other statistical methods can be used for detecting statistically significant shifts and variations, including Poisson distributions, Binomial distributions, or zero-inflated versions of the Poisson or Binomial distribution. Where v_{w} is the weekly variance, n_{w} is the number of weeks in the analysis, xᵢbar is the average weekly numbers of unique visitors associated with a given DUNS and given well-aligned semantic direction, and xi is the number of unique visitors associated with a given DUNS and given well-aligned semantic direction for the i^{th} week

At block 218, a report can be generated for a client user, for example, an interface showing a list of business entities showing statistically significant high engagement level with content in a well-aligned semantic direction.

For example, for client user, the system is configured to provide a report that shows those DUNS that are demonstrating increased interest/intent in a set of semantic directions that are consistent with the product/offering semantic directions. The client user is provided with a report that shows those DUNS that are demonstrating increased interest/intent in a set of semantic directions that are consistent with the product/offering semantic directions. The measure of how similar a set of content or a document is when compared to product content can be generated using techniques such as cosine angle or Euclidean distances for the semantic directions that are defined for each.

As will be appreciated, detecting intent algorithmically advantageously enables a vendor to automatically detect a potential customer's willingness to buy a product, perhaps from a competitor, be. A list of key phrases is used to locate signals with potentially relevant content that a potential prospect is engaging with online. For each newly identified web traffic visit record, and for each active model, the system is configured to analyze the web content for that visit and determine if the content is relevant to the semantic direction presented by the set of key phrases. This can be achieved by analyzing the semantic distance between the static embedding vectors from the or direct key phrase matches. As noted above, the semantic direction of the customer's product offering can be captured without the need for customer provided key words, though the customer can provide key words as well.

Once the system identifies the contextual intent, customer prospect interactions, for example ads, website interfaces, or live meetings can be tailored to the identified intent before engaging the customer.

When analyzing the semantic distance between the static embedding vectors or direct key phrase matches, there may not be alignment between the signal and the semantic direction, since even static word vectors are average representations of any given word independent of context. For example, capturing certain customer provided key phrases in the content can have misalignment between the signal and the semantic direction of the keywords. Accordingly, in an embodiment, described is an implementation to identify word and phrase matches that are “bad”, for example, bad URL analysis.

In an embodiment, a contextual pretrained language model such as Allen AI's ELMO, OpenAI's Open-GPT, or BERT (Bidirectional Encoder Representations from Transformers) can be used to generate-vectorized embeddings. In an implementation, BERT and similar embeddings generate vectors for each word in the input text sequence as well as an “average” CLS embedding that is meant to represent the whole segment. Alternatively, the vectors for the individual words could be averaged to represent the entire sequence.

In an implementation, pretrained embeddings can be fine-tuned on domain-data continuously to keep it up to date, allowing it to continuously adapt and transfer existing knowledge to changing data distributions. If being used for semantic similarity or classification, the embeddings can be fine-tuned for that task. In an embodiment, a model can be initially fine-tuned on a sentence similarity dataset, such as the Semantic Textual Similarity Benchmark (STS-B) subset of the General Language Understanding Evaluation (GLUE)/SuperGLUE datasets for instance. The STS-B is a collection of sentence pairs drawn from news headlines, video and image captions, and natural language inference data. Semantic Textual Similarity Multilingual and Cross-lingual Focused Evaluation, Cer et al. Proceedings of the 11th International Workshop on Semantic Evaluation (SemEval-2017) <https://www.aclweb.org/anthology/517-2001.pdf>. As will be understood from the teachings of the present disclosure, a transformer-based large language modeling architecture, such as BERT, DistilBERT, ALBERT can be fine-tuned accordingly.

In an embodiment, described is an algorithm that utilizes static embeddings and create heuristics to determine content relevancy by computing semantic similarity measures. While static embeddings are not configured to understand context in general, unlike contextual embedding such as BERT, they provide a technological advantage of being computationally cheaper and easier to deploy and scale. Accordingly, the present disclosure describes techniques of introducing context-awareness via higher-level heuristics. Described herein is a heuristic to remove bad URLS—matches that are contextually poor—which can be employed by the system for this purpose. Additionally, described is a feature importance measurement algorithm that can be used with static embeddings as described above to measure the contribution of any keyword or set of keywords to a match made.

### Bad URL Analysis

As noted above, in embodiments, the system can establish the semantic direction of the customer's product or service offering without use of keywords. In an embodiment, however, it was further found that improvements from leveraging customer provided or manually collected keywords were advantageous in accurately establishing the semantic direction.

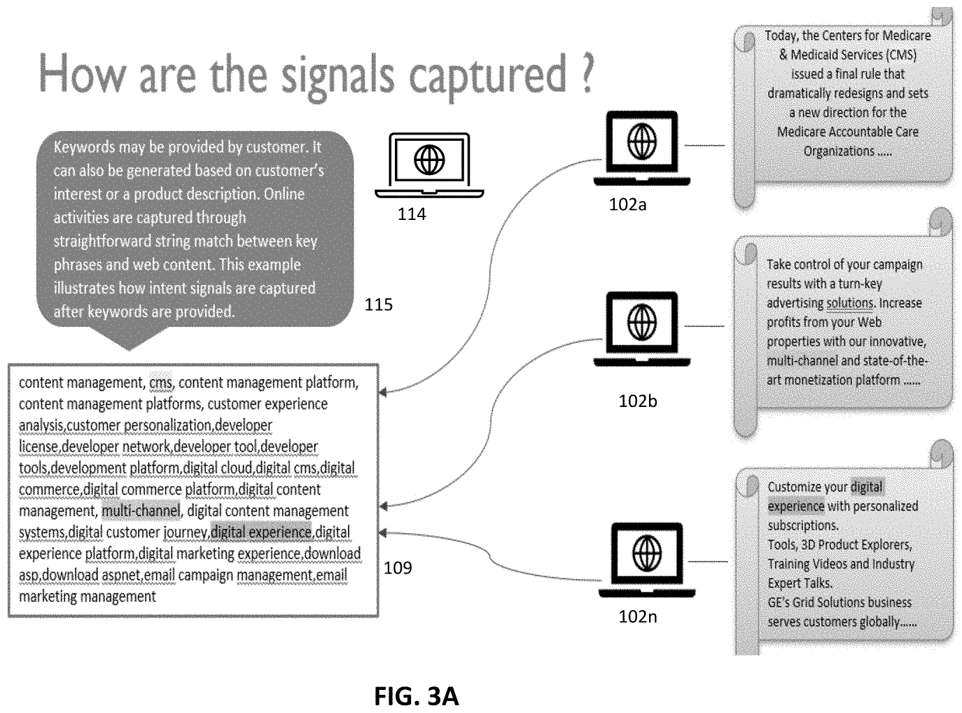

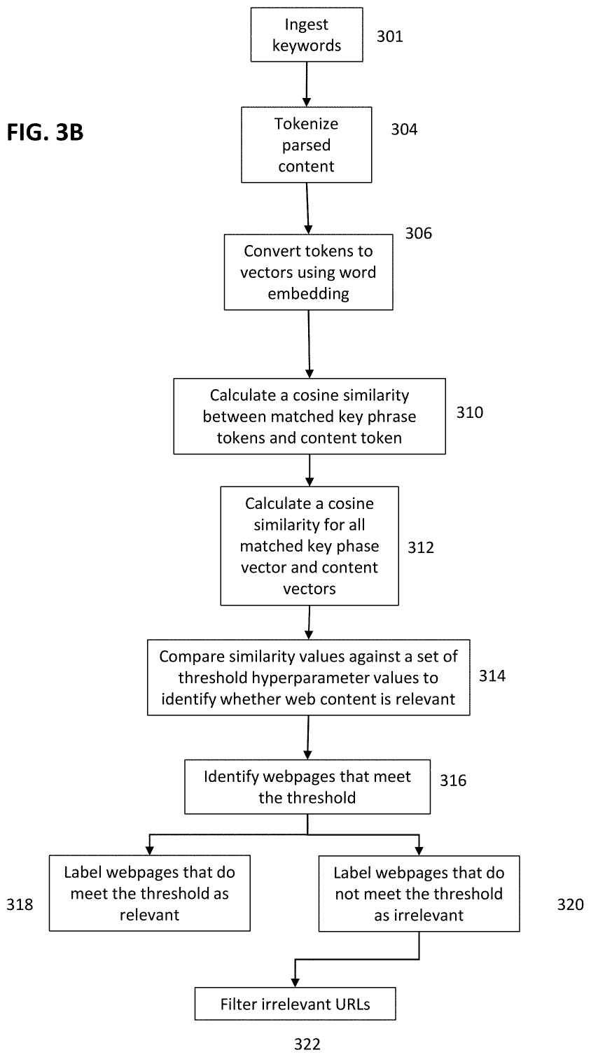

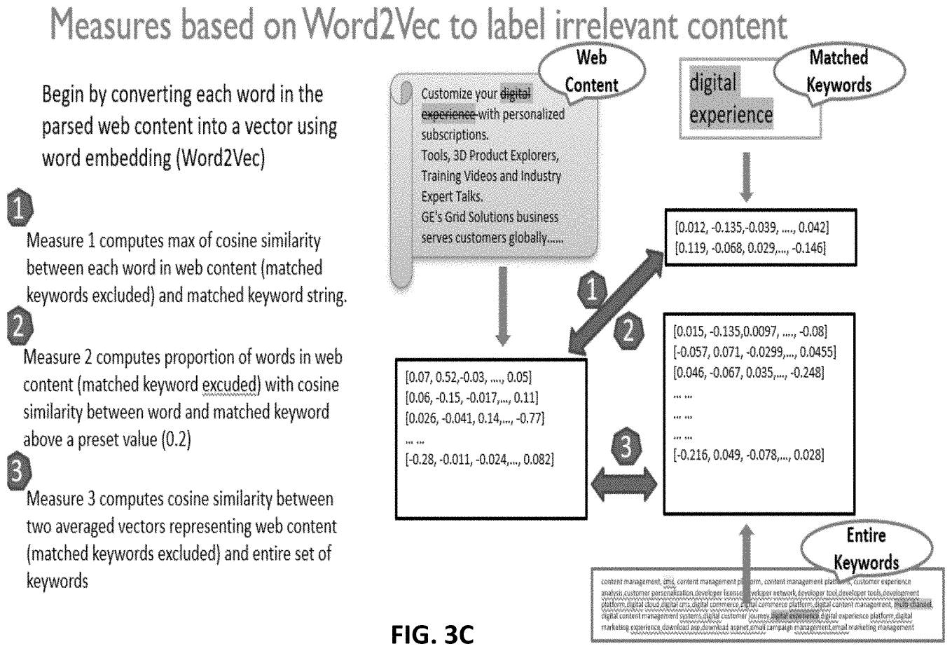

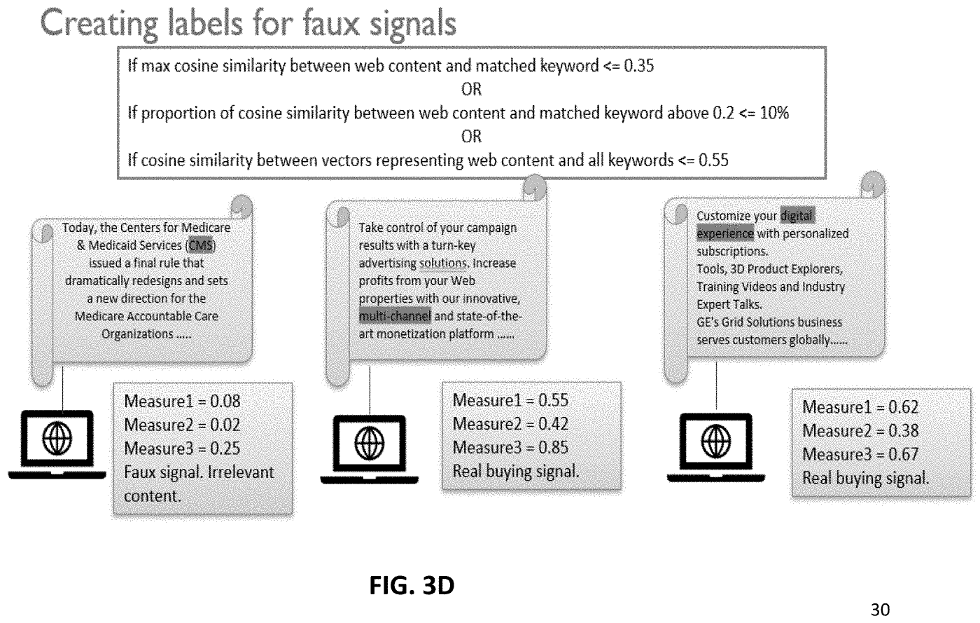

Embodiments described above use customer provided key phrases to match signals and assess content relevancy. For example, visits (alternatively, signals) with URL content containing an exact match for one or more provided keywords may be matched to a model. All matched visits then undergo similarity assessment using static word embeddings as described above to determine whether it is a signal with relevant content, before moving qualified signals onto the next stage of analysis. An example of key phrase matching and similarity assessment is illustrated in FIG. 3A. In one example, a client source 114 provides keywords 115 to a keyword database 109. In another example, keywords can be generated based on consumer interest or a product description. Online activities are captured using string matching between the key phrases in the database 109 and the web content 102a . . . n. As shown in FIG. 3A, intent signals can be garnered from web content 102a . . . n from website activity.

FIG. 3B is a flowchart showing a method of Bad URL analysis. At block 301, the system ingests keywords as submitted by a customer, for example to find prospects for a product or service it offers, for a word database 109 of keywords as described above. A block 302, the database 109 of parsed web content is pre-processed to remove all digits, punctuations, special characters and stop words before turning the content into tokens. At block 304, a database 109 of matched key phrase(s) are similarly pre-processed and cleaned and turned to tokens. At block 306, a trained classifier module, for example, FastText or Word2Vec, converts the tokens into vector representation and performs a lookup operation to locate word vectors. In an implementation, the system applies no truncation on the token content. If a token exists in a dictionary database, a ‘.vec’ file is used as lookup table to find the associated word vector. For an out-of-dictionary word, this work is broken apart into sub-words and a ‘.bin’ file is used to locate the word vector for each sub-word. At block 310, the system calculates a cosine similarity between each token in the matched key phrases or keyword string and each token in the web content before removing matched key phrases. At block 312, the system calculates a cosine similarity between the vectors presenting all matched key phrases and the vectors representing the content before removing matched key phrases. The system thereby computes the proportion of words in the web content with the cosine similarity between online content and matched keywords to assess whether similarity is above a preset value. The system also calculates a cosine similarity between two averaged vectors representing web content and an entire set of keywords. At block 314, the system then compares the similarity values against a set of threshold, hyperparameter values, to identify whether web content is relevant.

As shown in FIG. 3C, the system thereby derives three heuristic measures to assess the similarity between the web content and keywords, which can be either the matched key phrases or entire set of keywords, in an effort to determine content relevancy:
1. H1—Maximum cosine similarity between tokens in matched key phrases and tokens in the content.
2. H2—Proportion of cosine similarities between token in matched key phrases and those in the content.
3. H3—cosine similarity between the vector presenting all matched key phrases and the vector representing the content (after removing matched key phrases).

As explained below, these three measures can be employed to identify irrelevant or false signals from true ones.

At block 316, the system identifies webpages that do not meet the threshold(s). At block 318, if the webpage meets the threshold, the webpage is labelled as relevant. At block 320, if the webpage does not meet the threshold, the webpage is labelled as irrelevant or a bad URL. At block 322, the system can be configured to filter out the irrelevant or bad URLs.

Content is considered to be irrelevant, and a URL placed into bad URL list if a content score for one or more of the measures meets or exceeds a score threshold (e.g.: H1=>q1 or H2>q2=>or H3=>q3). The three threshold values, q1, q2 and q3,—are hyperparameters that can be optimally tuned if a limited amount of ground truth is available. Such ground truth may be obtained via, for example, a crowdsourcing platform, for example, Amazon Mechanical Turk (MTurk), by providing MTurk workers with content that requires a label and list of possible labels for a content to make a choice.

As shown in FIG. 3D, in an illustrative example, the criteria are set to be H1=>0.35 or H2=>0.10 or H3>=0.55. A first webpage comprises content that H1 measure of 0.08, an H2 measure of 0.02, and an H3 measure of 0.25. All three measures are below the hyperparameter thresholds; thus, the system is configured to label the URL as having irrelevant content. A second webpage comprises content that H1 measure of 0.55, an H2 measure of 0.42, and an H3 measure of 0.85. As all three signals are above the hyperparameter thresholds, the system is configured to label the URL as a real signal having relevant content. A third webpage comprises content that H1 measure of 0.62, an H2 measure of 0.38, and an H3 measure of 0.67. Again, as all three signals are above the hyperparameter thresholds, the system is configured to label the URL as a real signal having relevant content. The system can then be configured to filter out bad or irrelevant URLs. Of course, while three webpages are given as illustrations the system can be configured to process a database of thousands of web pages—the example being streamlined for ease of understanding. As noted above, the algorithms described herein are advantageously computational lightweight and thus can run efficiently at scale.

### Contextual Intent Classification With Contextual Embeddings

In an embodiment, the system can be configured to perform contextual intent classification with contextual embeddings. Contextual embeddings provide a number of additional advantages as compared to static embeddings. A system configured to execute contextual embedding can take advantage of transfer learning—via initialization of weights to those for similar customers—by learning from “little” training data. This enables the classifier models to be quickly repurposed. The classifier models are also directly “context-aware” aka “dynamic”—reducing false positives from direct keyword matching.

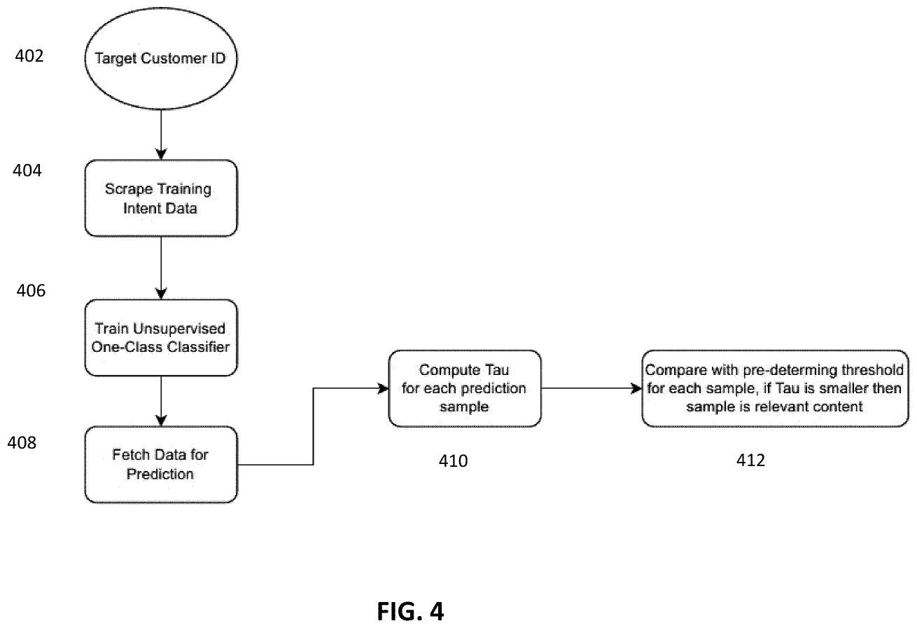

FIG. 4 is a flowchart describing a method for a system configured to perform context intent detection employing pretrained contextual embeddings. At block 402, a list of appropriate customers is stored in a database, such as a NoSQL database that supports key-value and document data models. An exemplary database can be, for example, DynamoDB, which can be employed to build serverless applications that can start small and scale globally to support petabytes of data and tens of millions of read and write requests per second.

At block 404, target customer key phrases are used to scrape online content representative of the key phrases as training data. A general or custom internet search engine could be used to do this automatically, or the data could be curated manually from a customer's website, from relevant product manuals, and so on. At block 406, the scraped results from a search engine are stored in a training database. At block 408, the system is configured to train an unsupervised one-class classifier, discussed in more detail below. The one class classifier can be run to detect whether any new signal is relevant to the customer or not. At block 410, the system is configured to compute Tau τ for each sample. “Compute Tau τ,” which is a statistic that can be computed for any web traffic signal based on its content. The value indicates the degree to which the content of the signal deviates from the semantic vector established by the underlying product or service of the Intent customer. At block 412, the system is configured to compare the computed τ to a pre-set empirically determined threshold value. Signals with tau below the threshold will be treated as signals with relevant content. Only signals considered to have relevant content to uncover a business identity (e.g., a DUNS identity) behind the signals are employed to produce an output file.

### One Class Classification

One-class classification (OCC), or unary classification or class-modelling, comprises a machine learning configured to identify objects of a specific class amongst all objects, by primarily learning from a training set containing only the objects of that class. One-class classification advantageously addresses problems for detecting relevant signals, because it is not clear what the “negative” class is for any given customer. By treating this as more of an “anomaly detection” problem in the beginning, training an OCC classifier provided innovative solution.

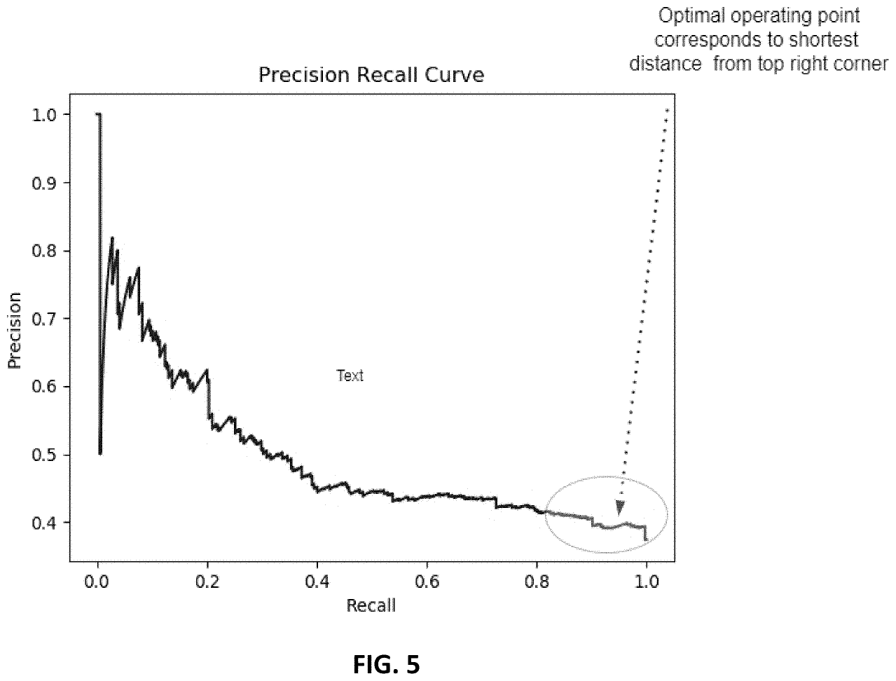

FIG. 5 shows a graph showing a precision recall curve for the experiment. A sample size of about 1000 on a variety of customers was discovered to be effective. This plots precision versus recall as the decision threshold is varied. Within the one class classification framework, there is a score τ, and an anomaly (irrelevant content) is detected if the score for that content is above τ. A sample precision-recall curve used to select optimal operating parameters shown in FIG. 5. A useful one class classifier is obtained if AUC is greater than proportion of positive samples in the ground truth data. In the case shown in FIG. 5, that ratio was about 0.37, and corresponds to a horizontal line in the curve around that value. The computed AUC in this case is 0.49, which is clearly larger.

It was found that contextual intent classification with contextual embeddings provided additional advantages as compared to static embeddings. In FIG. 5 the point closest to the top right corner of the graph, where recall and precision are both equal to 1, is an optimal operating point. This point corresponds to the highest f1-score—harmonic mean of precision and recall.

When ground truth is available, τ's cutoff value is determined by computing the tradeoff between precision and recall values over the full range of possible values of τ, which is displayed on a plot as shown in FIG. 5. As shown in FIG. 5, the optimal point on the precision/recall tradeoff curve corresponds to the shortest distance from top right corner. The corresponding value of τ for that point on the curve is the threshold value for τ. The optimal threshold value for τ can be determined when ground truth information on whether signals are content relevant is available. Accordingly, as will be appreciated, exploratory analysis can be carried out ahead of time to provide guideline for recommended values for τ according to the line of business to which the underlying product/content belongs.

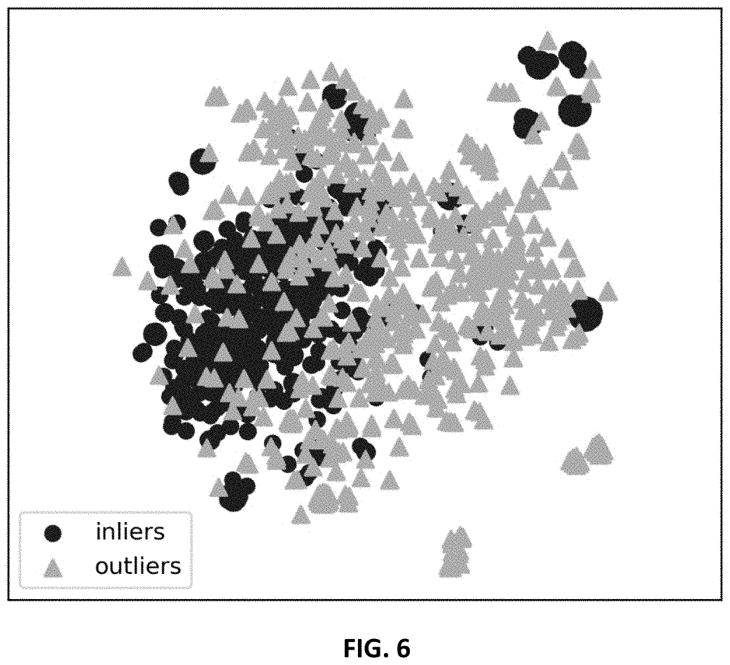

A variety of one class classification methods can be implemented. For example, the open-source Python Outlier Detection (PyOD) library pyod <https://github.com/yzhao062/pyod> includes more than 30 detection algorithms, such as LOF and COPOD. Zhao, Y., Nasrullah, Z. and Li, Z., 2019. PyOD: A Python Toolbox for Scalable Outlier Detection. Journal of machine learning research (JMLR), 20 (96), pp. 1-7. Alternatively, an autoencoder can be constructed for this stage using any neural network modeling network, for example such as Tensorflow. Other algorithms that can work include kNN. FIG. 6 shows a plot of a sample anomaly detection carried out for a sample customer using kNN as a one class classifier.

FIG. 5 shows the result of an experiment on a customer's web traffic data following the process described in FIG. 4. After scoring the web traffic data using the classifier obtained from 408 of FIG. 4, the signals can be separated into inliers (content relevant) and outliers (content irrelevant) using the threshold value of τ. As shown in FIG. 6 anomalies, or outliers, are samples that are not relevant to the customer under consideration, i.e., an irrelevant signal.

### Optimal Operation Parameter Selection

An optimizing aspect of deploying the one class classifier is the ability to automatically select optimal operating conditions. To select the best operating condition, given some ground truth data, a precision-recall curve was plotted using ground truth data. Table 1 shows an exemplary table giving the result of a precision recall experiment for 10 customers (9 shown).

TABLE 1

| Customer ID | tau_pr | N_samp | v1 Prec. | v1 Rec. | v2 Prec. | v2 Rec. |
|---|---|---|---|---|---|---|
| 1 | 1.84 | 839 | 0.832 | 0.521 | 0.781 | 0.977 |
| 2 | 2.2 | 1000 | 0.111 | 0.003 | 0.413 | 0.936 |
| 3 | 1.99 | 1000 | 0.636 | 0.056 | 0.572 | 0.86 |
| 4 | 2.2 | 822 | 0.5 | 0.009 | 0.44 | 0.907 |
| 5 | 1.9 | 807 | 0.82 | 0.082 | 0.73 | 0.827 |
| 6 | 1.97 | 1000 | 0.476 | 0.017 | 0.662 | 0.842 |
| 7 | 1.64 | 824 | 0 | 0 | 0.218 | 0.871 |
| 8 | 1.69 | 904 | 0.769 | 0.044 | 0.752 | 0.994 |
| 9 | 1.61 | 1000 | 0.612 | 0.109 | 0.686 | 0.941 |

In the experiment, web traffic signals from ten customer intent models (9 shown) representing products from various lines of business were sampled to test the performance of proposed algorithm based on heuristics (v1) and subsequent improvement using one-class classifier (v2). Ground truth on whether content is irrelevant were collected. As suggested by the precision and recall values across all ten customers in the experiment, V2 shows significantly better performance than V1. Precision values for V2 is mostly at par with those from V1 but recall values under V2 greatly exceed those under V1, indicating a model-based approach utilizing advanced embedding taking the context into consideration significantly outperforms the heuristics-based approach.

As will be appreciated, in embodiments databases and data therein, though shown in particular modules, can be shared and accessed across components and modules of the system and need not be located in specific components for access to the data for, among other things, semantic direction value analysis as described herein. The logical architecture and operational flows disclosed herein are illustrated to describe embodiments in an exemplary manner without limitations to a specific architecture, as skilled artisans may modify architecture design when, for instance, implementing the teachings of the present disclosure into their own systems.

### Illustrative Operating Environment

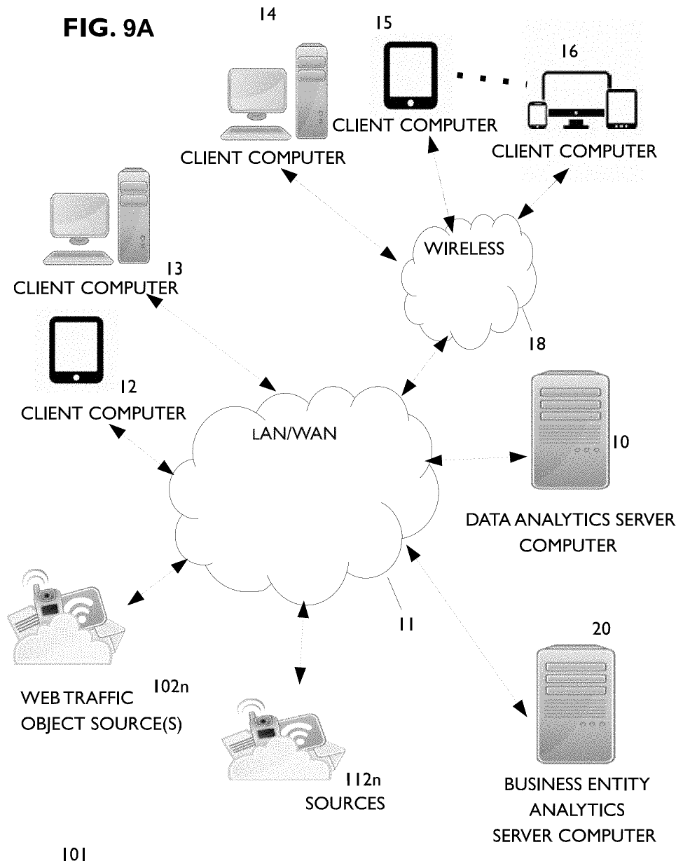

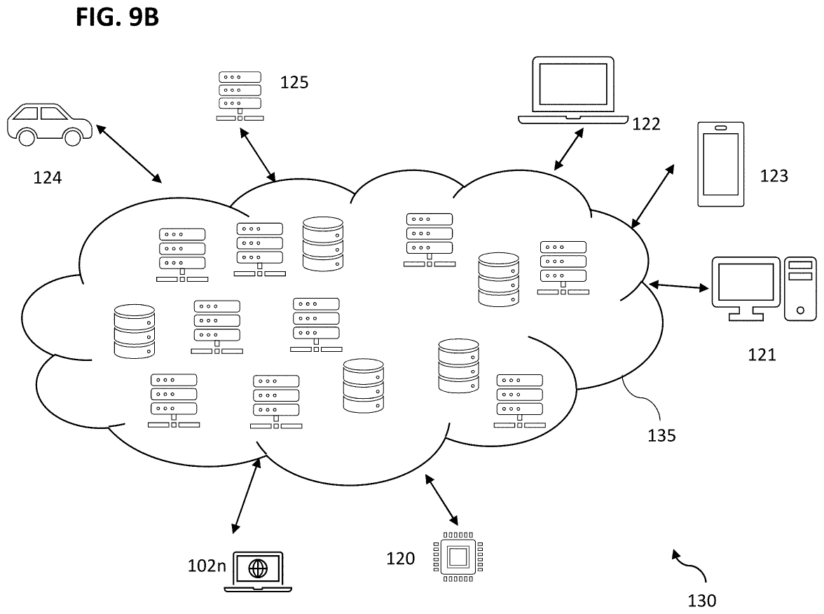

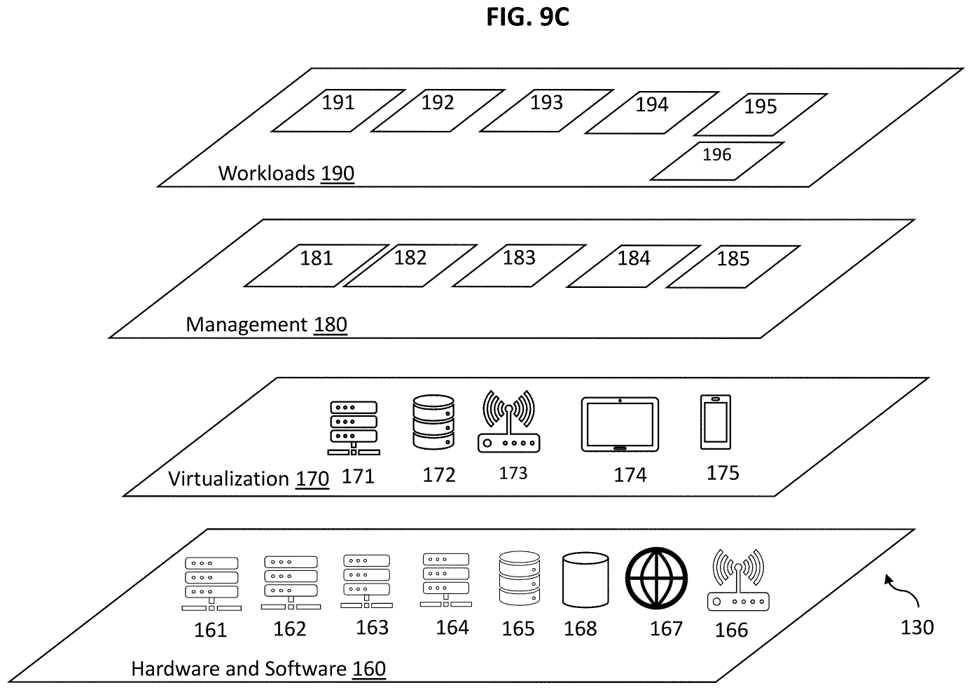

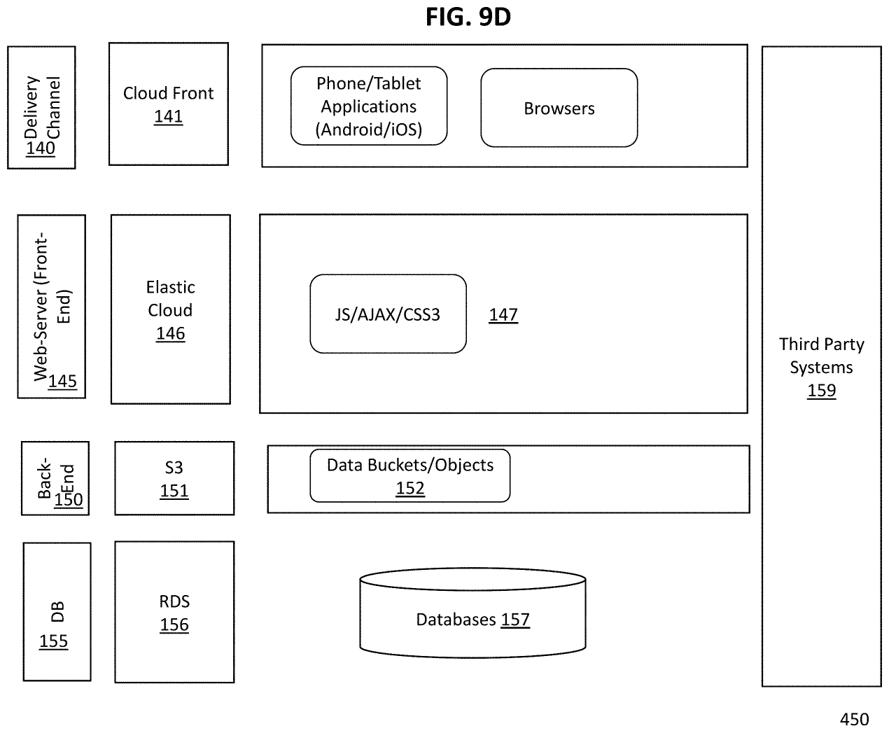

FIG. 9A shows components of an embodiment of an environment 101 in which embodiments of the present disclosure can be practiced. Not all of the components may be required to practice the innovations, and variations in the arrangement and type of the components can be made without departing from the spirit or scope of the present disclosure. As shown, FIG. 9A includes local area networks (LANs)/wide area networks (WANs) network 11, wireless network 18, client computers 12-16, Data Analytics Server Computer 10, a Business Entity Analytics Server Computer 20, Web Traffic Object Sources 102n and Other Data Sources 112n.

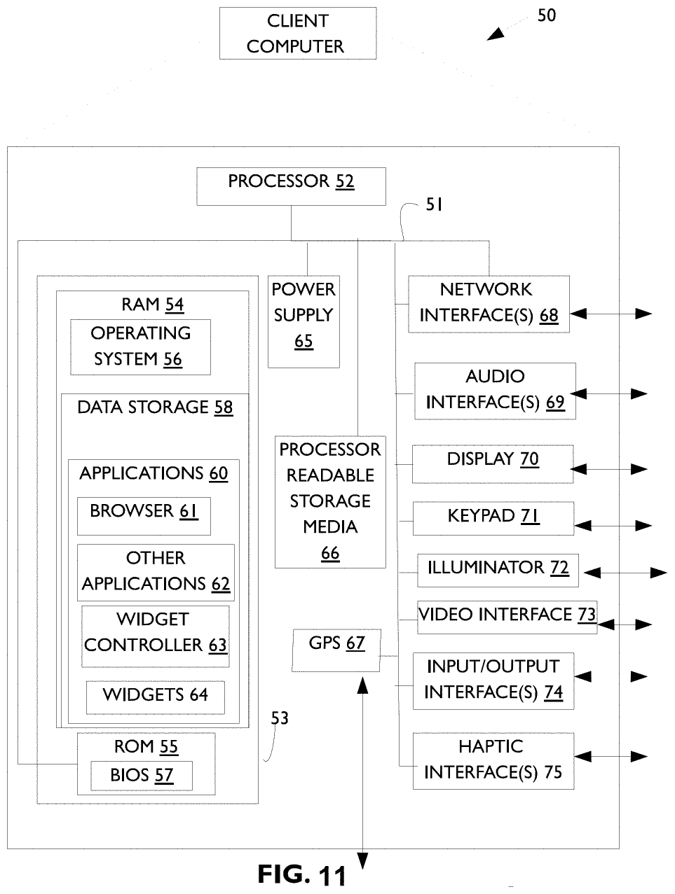

At least one embodiment of client computers 12-16 is described in more detail below in conjunction with FIG. 11. In one embodiment, at least some of client computers 12-16 can operate over a wired and/or wireless network, such as networks 11 and/or 18. Generally, client computers 12-16 can include virtually any computer capable of communicating over a network to send and receive information, perform various online activities, offline actions, or the like. In one embodiment, one or more of client computers 12-16 can be configured to operate in a business or other entity to perform a variety of services for the business or other entity. For example, client computers 12-16 can be configured to operate as a web server or an account server. However, client computers 12-16 are not constrained to these services and can also be employed, for example, as an end-user computing node, in other embodiments. It should be recognized that more or less client computers can be included within a system such as described herein, and embodiments are therefore not constrained by the number or type of client computers employed.

Computers that can operate as client computers 12-16 can include computers that typically connect using a wired or wireless communications medium, such as personal computers, multiprocessor systems, microprocessor-based or programmable electronic devices, network PCs, or the like. In some embodiments, client computers 12-16 can include virtually any portable personal computer capable of connecting to another computing device and receiving information, such as, laptop computer 13, smart mobile telephone 12, and tablet computers 15, and the like. However, portable computers are not so limited and can also include other portable devices, such as cellular telephones, radio frequency (RF) devices, infrared (IR) devices, Personal Digital Assistants (PDAs), handheld computers, wearable computers, integrated devices combining one or more of the preceding devices, and the like. As such, client computers 12-16 typically range widely in terms of capabilities and features. Moreover, client computers 12-16 are configured to access various computing applications, including a browser, or other web-based applications.

A web-enabled client computer can include a browser application that is configured to receive and to send web pages, web-based messages, and the like. The browser application can be configured to receive and display graphics, text, multimedia, and the like, employing virtually any web-based language, including wireless application protocol messages (WAP), and the like. In one embodiment, the browser application is enabled to employ Handheld Device Markup Language (HDML), Wireless Markup Language (WML), WMLScript, JavaScript, JavaScript Object Notation (JSON), Standard Generalized Markup Language (SGML), HyperText Markup Language (HTML), eXtensible Markup Language (XML), and the like, to display and send a message. In one embodiment, a user of the client computer can employ the browser application to perform various activities over a network (online). However, another application can also be used to perform various online activities.

Client computers 12-16 can also include at least one other client application that is configured to receive and/or send content with another computer. The client application can include a capability to send and/or receive content, or the like. The client application can further provide information that identifies itself, including a type, capability, name, and the like. In one embodiment, client computers 12-16 can uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client computers, Data Analytics Server Computer 10, Business Entity Analytics Server Computer 20, or other computers.

Client computers 12-16 can further be configured to include a client application that enables an end-user to log into an end-user account that can be managed by another computer, such as Data Analytics Server Computer 10, a Business Entity Analytics Server Computer 20, Web Traffic Object Sources 102n and Other Data Sources 112n, or the like. Such end-user account, in one non-limiting example, can be configured to enable the end-user to manage one or more online activities, including in one non-limiting example, search activities, social networking activities, browse various websites, communicate with other users, or the like. However, participation in such online activities can also be performed without logging into the end-user account.

Wireless network 18 is configured to couple client computers 14-16 and its components with network 11. Wireless network 18 can include any of a variety of wireless sub-networks that can further overlay stand-alone ad-hoc networks, and the like, to provide an infrastructure-oriented connection for client computers 14-16. Such sub-networks can include mesh networks, Wireless LAN (WLAN) networks, cellular networks, and the like. In one embodiment, the system can include more than one wireless networks.

Wireless network 18 can further include an autonomous system of terminals, gateways, routers, and the like connected by wireless radio links, and the like. These connectors can be configured to move freely and randomly and organize themselves arbitrarily, such that the topology of wireless network 18 may change rapidly.

Wireless network 18 can further employ a plurality of access technologies including 2nd (2G), 3rd (3G), 4th (4G) 5th (5G) generation radio access for cellular systems, WLAN, Wireless Router (WR) mesh, and the like. Access technologies, such as 2G, 3G, 4G, 5G, and future access networks can enable wide area coverage for mobile devices, such as client computers 14-16 with various degrees of mobility. In one non-limiting example, wireless network 18 can enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 18 can include virtually any wireless communication mechanism by which information may travel between client computers 14-16 and another computer, network, and the like.

Network 11 is configured to couple network computers with other computers and/or computing devices, including, Data Analytics Server Computer 10, a Business Entity Analytics Server Computer 20, Web Traffic Object Sources 102n and Other Data Sources, client computers 12, 13 and client computers 14-16 through wireless network 18. Network 11 is enabled to employ any form of computer readable media for communicating information from one electronic device to another. Also, network 11 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links in LANs typically include twisted wire pair or coaxial cable, while communication links between networks can utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links can further employ any of a variety of digital signalling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 11 can be configured to transport information of an Internet Protocol (IP). In essence, network 11 includes any communication method by which information can travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

One embodiment of a server computer that can be employed as a Data Analytics Server Computer 9A or a Business Entity Analytics Server Computer 20 is described in more detail below in conjunction with FIG. 11. Briefly, server computer includes virtually any network computer capable of hosting the modules as described herein. Computers that can be arranged to operate as a server computer include various network computers, including, but not limited to, desktop computers, multiprocessor systems, network PCs, server computers, network appliances, and the like.

Although FIG. 9A illustrates each of Data Analytics Server Computer 10 or a Business Entity Analytics Server Computer 20 as a single computer, the present disclosure is not so limited. For example, one or more functions of a server computer can be distributed across one or more distinct network computers. Moreover, the computer servers are not limited to a particular configuration. Thus, in one embodiment, a server computer can contain a plurality of network computers. In another embodiment, a server computer can contain a plurality of network computers that operate using a master/slave approach, where one of the plurality of network computers of the server computers are operative to manage and/or otherwise coordinate operations of the other network computers. In other embodiments, a server computer can operate as a plurality of network computers arranged in a cluster architecture, a peer-to-peer architecture, and/or even within a cloud architecture. Thus, the present disclosure is not to be construed as being limited to a single environment, and other configurations, and architectures are also envisaged.

Although illustrated separately, Data Analytics Server Computer 10 and Business Entity Analytics Server Computer 20 can be employed as a single network computer or computer platform, separate network computers, a cluster of network computers, or the like. In some embodiments, either Data Analytics Server Computer 10 and Business Entity Analytics Server Computer 20, or both, can be enabled to deliver content, respond to user interactions with the content, track user interaction with the content, update widgets and widgets controllers, or the like. Moreover, Data Analytics Server Computer 10 and Business Entity Analytics Server Computer 20 are described separately, and it will be appreciated that these servers hosted by or can be configured to operate on other platforms.

As described herein, embodiments of the system 10, processes and algorithms can be configured to run on a web services platform host such as Amazon Web Services (AWS)® or Microsoft Azure®. A cloud computing architecture is configured for convenient, on-demand network access to a shared pool of configurable computing resources (e.g., networks, network bandwidth, servers, processing, memory, storage, applications, virtual machines, and services). A cloud computer platform can be configured to allow a platform provider to unilaterally provision computing capabilities, such as server time and network storage, as needed automatically without requiring human interaction with the service's provider. Further, cloud computing is available over a network and accessed through standard mechanisms that promote use by heterogeneous thin or thick client platforms (e.g., mobile phones, laptops, and PDAs). In a cloud computing architecture, a platform's computing resources can be pooled to serve multiple consumers, partners or other third-party users using a multi-tenant model, with different physical and virtual resources dynamically assigned and reassigned according to demand. A cloud computing architecture is also configured such that platform resources can be rapidly and elastically provisioned, in some cases automatically, to quickly scale out and rapidly released to quickly scale in.

Cloud computing systems can be configured with systems to automatically control and optimize resource use by leveraging a metering capability at some level of abstraction appropriate to the type of service (e.g., storage, processing, bandwidth, and active user accounts). Resource usage can be monitored, controlled, and reported. As described herein, in embodiments, the system 10 is advantageously configured by the platform provider with innovative algorithms and database structures.

A cloud computing architecture includes a number of service and platform configurations.

A Software as a Service (SaaS) is configured to allow a platform provider to use the provider's applications running on a cloud infrastructure. The applications are accessible from various client devices through a thin client interface such as a web browser (e.g., web-based e-mail). The consumer typically does not manage or control the underlying cloud infrastructure including network, servers, operating systems, storage, or even individual application capabilities, with the possible exception of limited user-specific application configuration settings.

A Platform as a Service (PaaS) is configured to allow a platform provider to deploy onto the cloud infrastructure consumer-created or acquired applications created using programming languages and tools supported by the provider. The consumer does not manage or control the underlying cloud infrastructure including networks, servers, operating systems, or storage, but can have control over the deployed applications and possibly over the application hosting environment configurations.

An Infrastructure as a Service (IaaS) is configured to allow a platform provider to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

A cloud computing architecture can be provided as a private cloud computing architecture, a community cloud computing architecture, or a public cloud computing architecture. A cloud computing architecture can also be configured as a hybrid cloud computing architecture comprising two or more cloud platforms (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 9B, an illustrative cloud computing environment 130 is depicted. As shown, cloud computing environment 130 comprises one or more cloud computing nodes 135 with which local computing devices are used by cloud consumers, such as, for example, personal digital assistant (PDA) or cellular telephone 123, desktop computer 121, laptop computer 122, sensor data source 120, web traffic data source 102n, and integrated machine data source 124 and/or other computer system or device data source 125. Nodes 135 can communicate with one another. They can be grouped (not shown) physically or virtually, in one or more networks, such as private, community, public, or hybrid clouds as described herein, or a combination thereof. The cloud computing environment 130 is configured to offer infrastructure, platforms and/or software as services for which a cloud consumer does not need to maintain resources on a local computing device. It is understood that the types of computing devices shown in FIG. 9B are intended to be illustrative only and that computing nodes 135 and cloud computing environment 130 can communicate with any type of computerized device over any type of network and/or network addressable connection (e.g., using a web browser).

Referring now to FIG. 9C, a set of functional abstraction layers provided by cloud computing environment 130 (FIG. 9B) is shown. The components, layers, and functions shown in FIG. 9C are illustrative, and embodiments as described herein are not limited thereto. As depicted, the following layers and corresponding functions are provided:

A hardware and software layer 160 can comprise hardware and software components. Examples of hardware components include, for example: mainframes 161; servers 162; servers 163; blade servers 164; storage devices 165; and networks and networking components 166. In some embodiments, software components include network application server software 167 and database software 168.

Virtualization layer 170 provides an abstraction layer from which the following examples of virtual entities can be provided: virtual servers 171; virtual storage 172; virtual networks 173, including virtual private networks; virtual applications and operating systems 174; and virtual clients 175.

In one example, management layer 180 can provide the functions described below. Resource provisioning 181 provides dynamic procurement of computing resources and other resources that are utilized to perform tasks within the cloud computing environment. Metering and Pricing 182 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 183 provides access to the cloud computing environment for consumers and system administrators. Service level management 184 provides cloud computing resource allocation and management so that required service levels are met. Service Level Agreement (SLA) planning and fulfilment 185 provides pre-arrangement for, and procurement of, cloud computing resources for which a future requirement is anticipated in accordance with an SLA.

Workloads layer 190 provides examples of functionality for which the cloud computing environment can be utilized. Examples of workloads and functions that can be provided from this layer include mapping 191; input event processing 192, data stream processing 193; classifiers and AI models 194; data analytics 195; and data delivery 196.

FIG. 9D shows the logical architecture for an embodiment. The system can be built on an exemplary platform, for example Amazon Web Service platform, although other platforms for supporting application content delivery, social networking and network infrastructure can be employed. As shown in FIG. 9D, a Delivery Channel tier 140 can be provided via a cloud front 141 to client computers as described herein. A front-end web server tier 145 can be built on an elastic cloud (EC2) architecture 146 and can provide front end interfaces 147, for example such as interfaces built on Angular JS or other JS modules. The back-end tier 150 can be operatively connected to front end architecture tier 145 by web sockets, and can be built on an S3 architecture 151 and include data buckets and objects 152 for web-scale data storage and retrieval, and the databases layer 155 can include, for example, databases 157 on a Relational Database Structure 156 tier architecture. One or more third party systems 159 can be integrated or operatively connected to the architecture 450.

One of ordinary skill in the art will appreciate that the architecture of system is a non-limiting example that is illustrative of at least a portion of at least one of the various embodiments. As such, more or less components can be employed and/or arranged differently without departing from the scope of the innovations described herein. However, the system is sufficient for disclosing at least the innovations claimed herein.

Although this disclosure describes embodiments on a cloud computing platform, implementation of embodiments as described herein are not limited to a cloud computing environment.

### Illustrative Network Computer

FIG. 11 shows one embodiment of a network computer 21 according to one embodiment of the present disclosure. Network computer 21 can include many more or less components than those shown. The components shown, however, are sufficient to disclose an illustrative embodiment for practicing the invention. Network computer 21 can be configured to operate as a server, client, peer, a host, or any other computer. Network computer 21 can represent, for example Data Analytics Server Computer 10 and/or Business Entity Analytics Server Computer 20 of FIG. 3, and/or other network computers.

Network computer 21 includes processor 22, processor readable storage media 23, network interface unit 25, an input/output interface 27, hard disk drive 29, video display adapter 26, and memory 24, all in communication with each other via bus 28. In some embodiments, processor 22 can include one or more central processing units.

As illustrated in FIG. 11, network computer 21 also can communicate with the Internet, or some other communications network, via network interface unit 25, which is constructed for use with various communication protocols including the TCP/IP protocol. Network interface unit 25 is sometimes known as a transceiver, transceiving device, or network interface card (NIC).

Network computer 21 also comprises input/output interface 27 for communicating with external devices, such as a keyboard, or other input or output devices not shown in FIG. 12. Input/output interface 27 can utilize one or more communication technologies, such as USB, infrared, Bluetooth™, or the like.

Memory 24 generally includes a Random-Access Memory (RAM) 30, a Read-Only Memory (ROM) 31 and one or more permanent mass storage devices, such as hard disk drive 29, tape drive, optical drive, and/or floppy disk drive. Memory 24 stores operating system 32 for controlling the operation of network computer 21. Any general-purpose operating system can be employed. Basic input/output system (BIOS) 42 is also provided for controlling the low-level operation of network computer 21.

Although illustrated separately, memory 24 can include processor readable storage media 23. Processor readable storage media 23 may be referred to and/or include computer readable media, computer readable storage media, and/or processor readable storage device. Processor readable storage media 23 can include volatile, non-volatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media that can be used to store the desired information and which can be accessed by a computer.

Memory 24 further includes one or more data storage 33, which can be utilized by network computer 21 to store, among other things, applications 35 and/or other data. For example, data storage 33 can also be employed to store information that describes various capabilities of network computer 21. The information can then be provided to another computer based on any of a variety of events, including being sent as part of a header during a communication, sent upon request, or the like. Data storage 33 can also be employed to store messages, web page content, or the like. At least a portion of the information can also be stored on another component of network computer 21, including, but not limited to processor readable storage media 23, hard disk drive 29, or other computer readable storage medias (not shown) within network computer 21.

Data storage 33 can include a database, text, spreadsheet, folder, file, or the like, that may be configured to maintain and store user account identifiers, user profiles, email addresses, IP addresses, and/or other network addresses; or the like.

In at least one of the various embodiments, data storage 33 can include databases 103, for example word database(s) and other databases that can contain information determined from web analysis and network activity metrics as described herein, for example, unique visits (date-time stamps, IP address) and unique visitors (different cookies, different IP addresses).

Data storage 33 can further include program code, data, algorithms, and the like, for use by a processor, such as processor 22 to execute and perform actions. In one embodiment, at least some of data storage 33 might also be stored on another component of network computer 21, including, but not limited to processor-readable storage media 23, hard disk drive 29, or the like.

Applications 35 can include computer executable instructions, which may be loaded into mass memory, and run on operating system 32. Examples of application programs can include transcoders, schedulers, calendars, database programs, word processing programs, Hypertext Transfer Protocol (HTTP) programs, customizable user interface programs, IPsec applications, encryption programs, security programs, SMS message servers, IM message servers, email servers, account managers, and so forth. Applications 35 can also include website server 36, Language Processing Classifier 101, a Web Scraper Module for web traffic data content 102, Business Entity Identity Resolution Module 103, Semantic Direction Module 104, Business Entity Mapping Module 106, Vector Generation Module 108, Vector Comparator Module 110, and Report Generator 37.

Website server 36 can represent any of a variety of information and services that are configured to provide content, including messages, over a network to another computer. Thus, website server 36 can include, for example, a web server, a File Transfer Protocol (FTP) server, a database server, a content server, or the like. Website server 36 can provide the content including messages over the network using any of a variety of formats including, but not limited to WAP, HDML, WML, SGML, HTML, XML, Compact HTML (cHTML), Extensible HTML (xHTML), or the like.

Language Processing Classifier 101, a Web Scraper Module for web traffic data content 102, Business Entity Identity Resolution Module 103, Semantic Direction Module 104, Business Entity Mapping Module 106, Vector Generation Module 108, Vector Comparator Module 110, and Report Generator 37 can be operative on or hosted and operative on Data Analytics Server Computer 10 and/or Business Entity Analytics Server Computer 20 of FIG. 9A. Report Generator 37 can employ processes, or parts of processes, similar to those described in conjunction with FIGS. 1-9 to perform at least some of its actions.

Report Generator 37 can be arranged and configured to determine and/or generate reports based on the user filters and controls similar to those described above with reference to the user interface 30 controls. Also, Report Generator 37 can be configured to output a tailored report, either in the form of publishing software application which prepares and outputs a listing in a convenient-to-read form, or the same information output in a format suitable for automatic input and processing by another software product, for example plain text for a publishing program such as LaTeX. In at least one of the various embodiments, Report Generator 37 can be operative on or hosted and operative on Data Analytics Server Computer 10 and/or Business Entity Analytics Server Computer 20 of FIG. 9A. Report Generator 37 can employ processes, or parts of processes, similar to those described in conjunction with FIGS. 1-2 to perform at least some of its actions. Report Generator can be employed to output reports for the interfaces as shown in FIGS. 6-9.

### Illustrative Client Computer

Referring to FIG. 12, Client Computer 50 can include many more or less components than those shown in FIG. 12. However, the components shown are sufficient to disclose an illustrative embodiment for practicing the innovations described herein.

Client Computer 50 can represent, for example, one embodiment of at least one of Client Computers 12-16 of FIG. 3.

As shown in the figure, Client Computer 50 includes a processor 52 in communication with a mass memory 53 via a bus 51. In some embodiments, processor 52 includes one or more central processing units (CPU). Client Computer 50 also includes a power supply 65, one or more network interfaces 68, an audio interface 69, a display 70, a keypad 71, an illuminator 72, a video interface 73, an input/output interface 74, a haptic interface 75, and a global positioning system (GPS) receiver 67.

Power supply 65 provides power to Client Computer 50. A rechargeable or non-rechargeable battery can be used to provide power. The power can also be provided by an external power source, such as an alternating current (AC) adapter or a powered docking cradle that supplements and/or recharges a battery.

Client Computer 50 may optionally communicate with a base station (not shown), or directly with another computer. Network interface 68 includes circuitry for coupling Client Computer 50 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra-wide band (UWB), IEEE 802.16 Worldwide Interoperability for Microwave Access (WiMax), session initiated protocol/real-time transport protocol (SIP/RTP), or any of a variety of other wireless communication protocols. Network interface 68 is sometimes known as a transceiver, transceiving device, or network interface card (NIC).

Audio interface 69 is arranged to produce and receive audio signals such as the sound of a human voice. For example, audio interface 69 can be coupled to a speaker and microphone (not shown) to enable telecommunication with others and/or generate an audio acknowledgement for some action.

Display 70 can be a liquid crystal display (LCD), gas plasma, light emitting diode (LED), organic LED, or any other type of display used with a computer. Display 70 can also include a touch sensitive screen arranged to receive input from an object such as a stylus or a digit from a human hand.

Keypad 71 can comprise any input device arranged to receive input from a user. For example, keypad 71 can include a push button numeric dial, or a keyboard. Keypad 71 can also include command buttons that are associated with selecting and sending images. Illuminator 72 can provide a status indication and/or provide light. Illuminator 72 can remain active for specific periods of time or in response to events. For example, when illuminator 72 is active, it can backlight the buttons on keypad 71 and stay on while the Client Computer is powered. Also, illuminator 72 can backlight these buttons in various patterns when particular actions are performed, such as dialing another client computer. Illuminator 72 can also cause light sources positioned in a transparent or translucent case of the client computer to illuminate in response to actions.

Video interface 73 is arranged to capture video images, such as a still photo, a video segment, an infrared video, or the like. For example, video interface 73 can be coupled to a digital video camera, a web-camera, or the like. Video interface 73 can comprise a lens, an image sensor, and other electronics. Image sensors may include a complementary metal-oxide-semiconductor (CMOS) integrated circuit, charge coupled device (CCD), or any other integrated circuit for sensing light.

Client Computer 50 also comprises input/output interface 74 for communicating with external devices, such as a headset, or other input or output devices not shown in FIG. 13. Input/output interface 74 can utilize one or more communication technologies, such as USB, infrared, Bluetooth™, or the like.

Haptic interface 75 is arranged to provide tactile feedback to a user of the Client Computer 50. For example, the haptic interface 75 can be employed to vibrate Client Computer 50 in a particular way when another user of a computing computer is calling. In some embodiments, haptic interface 75 is optional.

Client Computer 50 can also include GPS transceiver 67 to determine the physical coordinates of Client Computer 50 on the surface of the Earth. GPS transceiver 67, in some embodiments, is optional. GPS transceiver 67 typically outputs a location as latitude and longitude values. However, GPS transceiver 67 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of Client Computer 50 on the surface of the Earth. It is understood that under different conditions, GPS transceiver 67 can determine a physical location within millimeters for client computer 50. In other cases, the determined physical location may be less precise, such as within a meter or significantly greater distances. In one embodiment, however, Client Computer 50 can, through other components, provide other information that can be employed to determine a physical location of the computer, including for example, a Media Access Control (MAC) address, IP address, or the like.

Mass memory 53 includes a Random-Access Memory (RAM) 54, a Read-only Memory (ROM) 55, and other storage means. Mass memory 53 illustrates an example of computer readable storage media (devices) for storage of information such as computer readable instructions, data structures, program modules or other data. Mass memory 53 stores a basic input/output system (BIOS) 57 for controlling low level operation of Client Computer 50. The mass memory also stores an operating system 56 for controlling the operation of Client Computer 50. It will be appreciated that this component can include a general-purpose operating system such as a version of UNIX, or LINUX™, or a specialized client communication operating system such as Microsoft Corporation's Windows™ OS, Apple Corporation's iOS™, Google Corporation's Android™ or the Symbian® operating system. The operating system can include, or interface with a Java virtual machine module that enables control of hardware components and/or operating system operations via Java application programs.

Mass memory 53 further includes one or more data storages 58 that can be utilized by Client Computer 50 to store, among other things, applications 60 and/or other data. For example, data storage 58 can also be employed to store information that describes various capabilities of Client Computer 50. The information can then be provided to another computer based on any of a variety of events, including being sent as part of a header during a communication, sent upon request, or the like. Data storage 58 can also be employed to store social networking information including address books, buddy lists, aliases, user profile information, or the like. Further, data storage 58 can also store message, web page content, or any of a variety of user generated content. At least a portion of the information can also be stored on another component of Client Computer 50, including, but not limited to processor readable storage media 66, a disk drive or other computer readable storage devices (not shown) in Client Computer 50.

Processor readable storage media 66 can include volatile, non-volatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium that can be used to store the desired information and which can be accessed by a computer. Processor readable storage media 66 is also referred to herein as computer readable storage media and/or computer readable storage device.

Applications 60 can include computer executable instructions which, when executed by Client Computer 50, transmit, receive, and/or otherwise process network data. Network data includes, but is not limited to, messages (e.g., SMS, Multimedia Message Service (MMS), instant message (IM), email, and/or other messages), audio, video, and enable telecommunication with another user of another Client Computer 50.

Applications 60 can include, for example, browser 61, and other applications 62. Other applications 62 include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 61 can include virtually any application configured to receive and display graphics, text, multimedia, messages, and the like, employing virtually any web-based language. In one embodiment, the browser application employs HDML, WML, WMLScript, JavaScript, JSON, SGML, HTML, XML, and the like, to display and send a message. However, any of a variety of other web-based programming languages can be employed. In one embodiment, browser 61 enables a user of Client Computer 50 to communicate and interface with another network computer, such as Data Analytics Server Computer 10, a Business Entity Analytics Server Computer 20, Web Traffic Object Sources 102n and Other Data Sources 112n of FIG. 3 such that a user can operate a user interface 30 as described herein.

Applications 60 can also include Widget Controller 63 and one or more Widgets 64. Widgets 64 can be collections of content provided to the Client Computer by Data Analytics Server Computer 10, a Business Entity Analytics Server Computer 20, Web Traffic Object Sources 102n and Other Data Sources 112n. Data Analytics Server Computer 10, a Business Entity Analytics Server Computer 20, Web Traffic Object Sources 102n and Other Data Sources 112n of FIG. 3. Widget Controller 63 and Widgets 64 can run as native Client Computer applications, or they can run in Browser 61 as web browser-based applications. Also, Widget Controller 63 and Widgets 64 can be arranged to run as native applications or web browser applications, or combination thereof. In one embodiment, browser 61 employs Widget Controller 63 and Widgets 64 to enable a user of Client Computer 50 to communicate and interface with another network computer, such as Data Analytics Server Computer 10, a Business Entity Analytics Server Computer 20, Web Traffic Object Sources 102n and Other Data Sources 112n of FIG. 3 such that a user can operate a user interface 30 as described herein.

### Illustrative Graphical User Interface

Referring to FIGS. 6-9, in at least one of the various embodiments, user interfaces other than user interfaces 30 described below, can be employed without departing from the spirit and/or scope of the present disclosure. Such user interfaces can have more or fewer user interface elements that are arranged in various ways. In some embodiments, user interfaces can be generated using web pages, mobile applications, emails, PDF documents, text messages, or the like. In at least one of the various embodiments, Language Processing Classifier 101, Web Scraper Module for web data traffic content 102, Identity Resolution Module 103, Semantic Direction Module 104, Business Entity Mapping Module 106, Vector Generation Module 108, Vector Comparator Module 110, and Report Generator 37 can include processes and/or API's for generating user interfaces, such as, user interfaces 30.

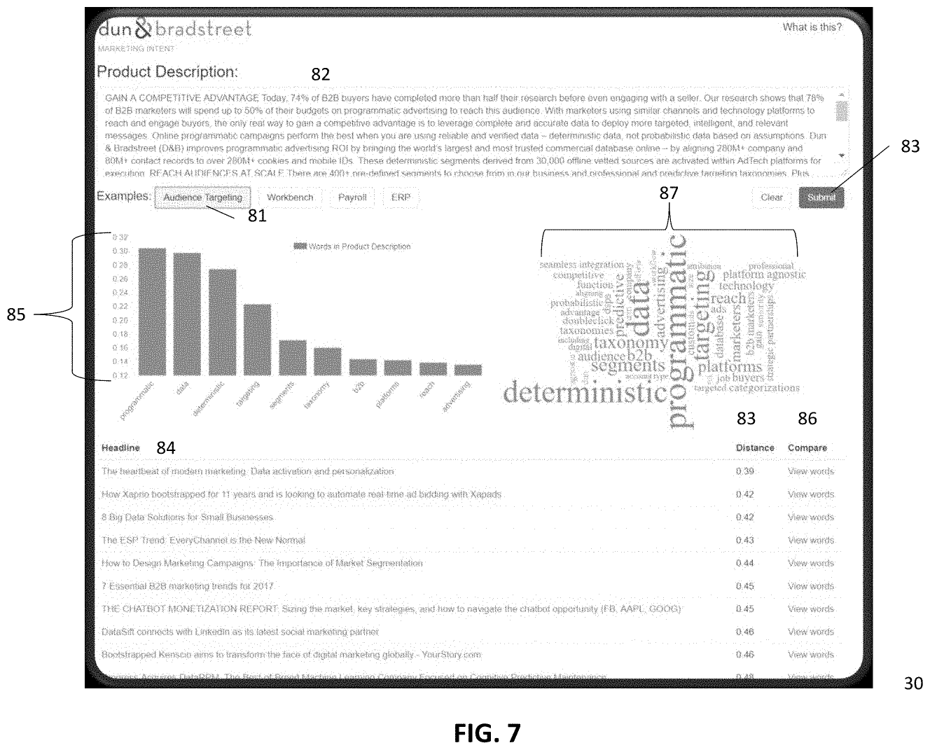

The user interface unit 30 is now described in more detail. As shown in FIG. 7, the interface 30 can be configured for, inter alia, audience targeting 81 using semantic directions. In an embodiment, the system produces a display showing semantic distance values 83 for words and web content (e.g., articles) 84 visited by mapped and tracked entities and a product description 82. The interface includes an interface object 80 that allows the user to enter and submit a product description as described herein. For example, as described herein, the product descriptions can be obtained from a set of documented product definitions, for example payroll management software as software used for tracking, or sets of representative product documentation, for example, a web page from a company that sells payroll management products and another web page for a different payroll management product. The interface 30 includes an interface object 86 that allows the user to view and compare the product description words. The interface 30 can be configured to show words common to both the product descriptions and web pages and words unique to one or more selected web pages 84 (e.g., a page including an article with a given headline). The interface can be configured to show, for example, a word map 87 visually depicting the word weights for the semantic values of the product description words. The interface 30 can be configured to show other graphics, for example, a bar graph 85 visually depicting the term frequency weights for the product description words.

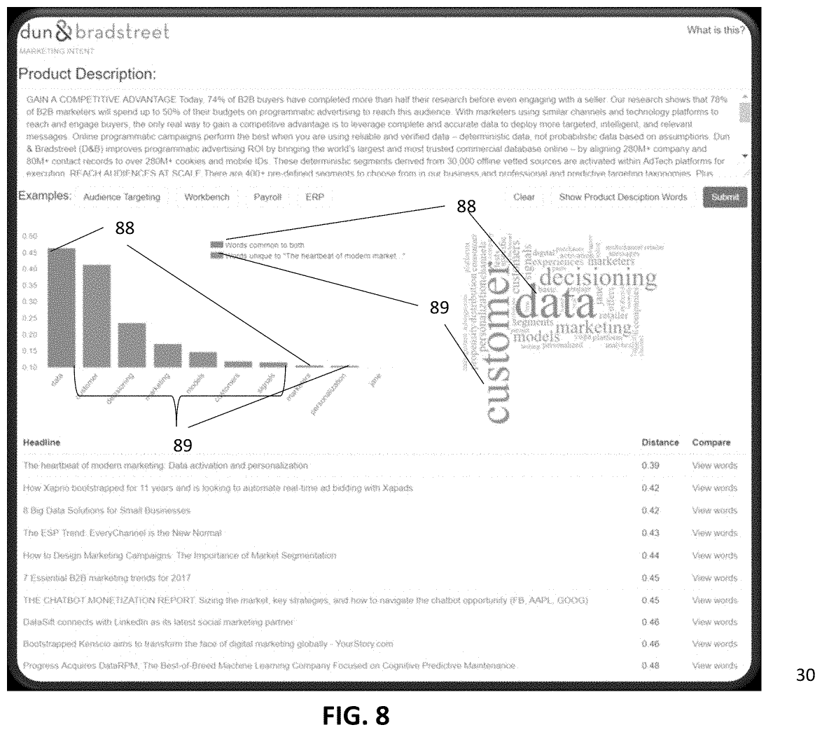

As shown in FIG. 8, the user can select a filter to show product description words. For example, the graphics (e.g., bar graph 85 and word map 87) can show words common to both the product descriptions and web pages 88 in one color or pattern, and words unique to one or more selected web pages 88 (e.g., a page including an article with a given headline).

The user interface 30 has been described using the example of a dashboard suitable for a personal computer, as this is an amenable form for the purpose of explanation. Similar graphical user interfaces with a dashboard format can also be provided as a mobile app, e.g., for Android or iPhone operating systems, where the term “mobile app” refers primarily to a module of applications software capable of running on a smart phone or tablet device or other client computer. Other types of user interface can also be provided. An alternative user interface type is an application programming interface (API), which is the type of user interface which would be suitable for developers who wish to integrate the system as described herein with a third-party software application, e.g., to incorporate outputs in a flexible manner suited to the third-party applications software which is being integrated. Another user interface type would be a report writing software application, which, based on user filters and controls similar to those described above with reference to the dashboard, will output a tailored report.

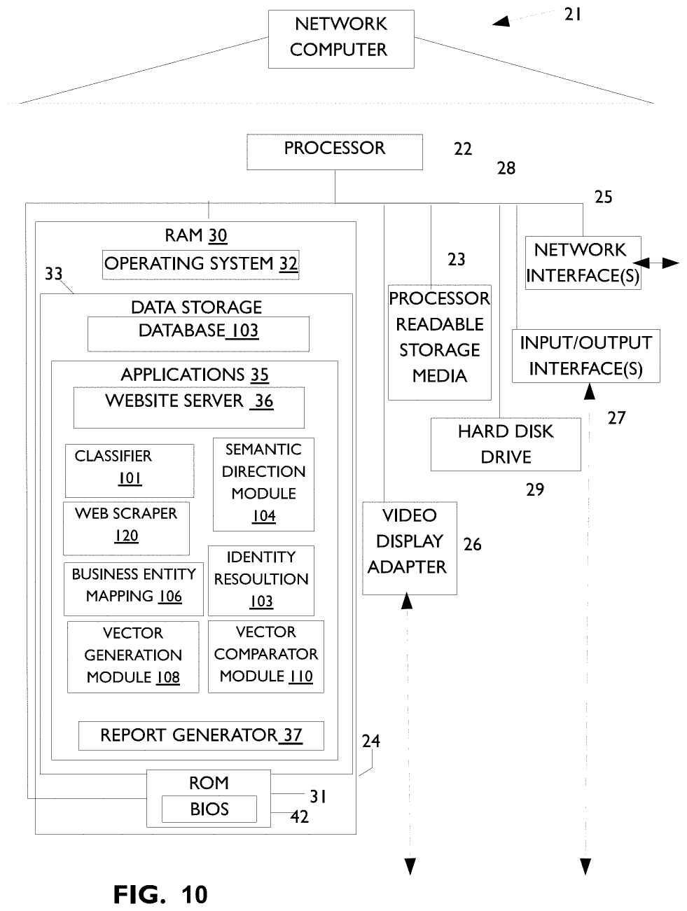

The operation of certain aspects of the present disclosure have been described with respect to flowchart illustrations. In at least one of various embodiments, processes described in conjunction with FIGS. 1 to 12, can be implemented by and/or executed on a single network computer. In other embodiments, these processes or portions of these processes can be implemented by and/or executed on a plurality of network computers. Likewise, in at least one of the various embodiments, processes or portions thereof, can operate on one or more client computers, such as client computer. However, embodiments are not so limited, and various combinations of network computers, client computers, virtual machines, or the like can be used. Further, in at least one of the various embodiments, the processes described in conjunction with the flowchart illustrations can be operative in system with logical architectures, such as those described in herein.

It will be understood that each block of the flowchart illustrations described herein, and combinations of blocks in the flowchart illustrations, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the present disclosure.

Accordingly, blocks of the flowchart illustrations support combinations for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions. The foregoing examples should not be construed as limiting and/or exhaustive, but rather, as illustrative use cases to show an implementation of at least one of the various embodiments of the present disclosure.

What is claimed is:

1. A method being performed by a computer system that comprises one or more processors and a computer-readable storage medium encoded with program instructions executable by at least one of the processors and operatively coupled to at least one of the processors, the method comprising:
ingesting or generating keywords and saving the keywords to a keyword database;
obtaining web content for a webpage for a web content word database comprising words from the webpage;
identifying one or more web content phrases that match the keywords to obtain one or more matched key phrases;
converting the one or more matched key phrases to one or more matched key phrase tokens;
converting the remaining web content words from the web content word database to web content tokens;
converting the one or more matched key phrase tokens to a matched key phrase vector;
converting the web content tokens to a web content vector;
computing, a cosine similarity between each of the web content tokens and each of the one or more matched key phrase tokens;
computing a cosine similarity between the web content vector and the matched key phrase vector representing all the matched key phrases;
implementing at least one hyperparameter threshold from the cosine similarity computations to identify irrelevant webpages in the web content.

2. The method of claim 1, wherein the at least one hyperparameter comprises a hyperparameter is selected from the group consisting of:
a maximum cosine similarity between the matched key phrase tokens and the web content tokens;
a proportion of the cosine similarities between matched key phrase tokens and the web content tokens; and
the cosine similarity of the web content vector and the matched key phrase vector representing all the matched key phrases.

3. A method being performed by a computer system that comprises one or more processors and a computer-readable storage medium encoded with program instructions executable by at least one of the processors and operatively coupled to at least one of the processors, the method comprising:
storing a list of target customers in a database;
employing target customer key phrases to obtain online website content and saving the online website content to a word training database;
training an unsupervised One Class Classifier on the word training database.

4. A computer system comprising:
a network computer, including:
a transceiver for communicating over the network;
a memory for storing at least instructions and a word database; and
a processor device that is operative to execute program instructions that enable actions for executing the instructions to at least.
ingest or generate keywords and saving the keywords to a keyword database;
obtain web content for a webpage for a web content word database comprising words from the webpage;
identify one or more web content phrases that match the keywords to obtain one or more matched key phrases;
convert the one or more matched key phrases to one or more matched key phrase tokens;
convert the remaining web content words from the web content word database to web content tokens;
convert the one or more matched key phrase tokens to a matched key phrase vector;
convert the web content tokens to a web content vector;
compute, a cosine similarity between each of the web content tokens and each of the one or more matched key phrase tokens;
compute a cosine similarity between the web content vector and the matched key phrase vector representing all the matched key phrases; and
implement at least one hyperparameter threshold from the cosine similarity computations to identify irrelevant webpages in the web content.

5. The computer system of claim 4, wherein the at least one hyperparameter comprises at least one hyperparameter selected from the group consisting of:
a maximum cosine similarity between the matched key phrase tokens and the web content tokens;
a proportion of the cosine similarities between matched key phrase tokens and the web content tokens; and
the cosine similarity of the web content vector and the matched key phrase vector representing all the matched key phrases.

6. A computer system comprising:
a network computer, including:
a transceiver for communicating over the network;
a memory for storing at least instructions and a word database; and
a processor device that is operative to execute program instructions that enable actions for executing the instructions to at least:
storing a list of target customers in a database;
employing target customer key phrases to obtain online website content and saving the online website content to a word training database; and
training an unsupervised One Class Classifier on the word training database.

7. A computer program product storing the program instructions of claim 4.

8. A computer program product storing the program instructions of claim 6.
